(19) United States
(12) Patent Application Publication
(10) Pub. No.: US 2026/0202340 A1
(43) Pub. Date: Jul. 16, 2026

(54) SPECTRAL SENSING OF PROCESS CHAMBER CONDITIONS

(71) Applicant: Lam Research Corporation, Fremont, CA (US)

(72) Inventors: Benjamin Tong Yee, Portland, OR (US); Yukinori Sakiyama, West Linn, OR (US); Kapil Sawlani, West Linn, OR (US)

(21) Appl. No.: 19/134,666

(22) PCT Filed: Nov. 29, 2023
(86) PCT No.: PCT/US2023/081699

§ 371 Date: May 30, 2025

Related U.S. Application Data
(60) Provisional application No. 63/385,842, filed on Dec. 2, 2022.

(51) Int. Cl. G01N 21/77; B08B 9/00; B08B 13/00

(52) U.S. Cl. CPC G01N 21/77; B08B 9/00; B08B 13/00

(57) ABSTRACT

Methods, apparatus, and various use applications for spectral sensing of a condition of a process chamber of a semiconductor device manufacturing apparatus are provided.

### RELATED APPLICATION(S)

A PCT Request Form is filed concurrently with this specification as part of the present application. Each application that the present application claims benefit of or priority to as identified in the concurrently filed PCT Request Form is incorporated by reference herein in its entirety and for all purposes.

### BACKGROUND

Sensors associated with semiconductor device manufacturing equipment, such as a multi-station fabrication tools (including, e.g., multi-station process chambers), include sensors that are employed for specific task or specific class of problems. As such, sensors can detect and collect a specific type of useful information. For example, optical emission spectroscopy (OES) measures the spectral content of electromagnetic radiation such as light emitted within the aforementioned process chamber(s). Such light may be caused by chemical reactions (e.g., chemiluminescence) or excitation of gas species with plasma introduced into a process chamber.

Background and contextual descriptions contained herein are provided solely for the purpose of generally presenting the context of the disclosure. Much of this disclosure presents work of the inventors, and simply because such work is described in the background section or presented as context elsewhere herein does not mean that it is admitted to be prior art.

### SUMMARY

In one aspect of the present disclosure, a semiconductor device manufacturing apparatus is disclosed. In some embodiments, the semiconductor device manufacturing apparatus includes: a process chamber; at least one sensor having access to the process chamber; and a controller communicatively coupled to the at least one sensor, the controller configured to: (a) introduce a chamber cleaning species to the process chamber to remove a coating from one or more components of the process chamber without excitation or generation of a plasma within the process chamber; (b) detect, using the at least one sensor, spectral characteristics of electromagnetic radiation emitted in the process chamber during chamber cleaning; and (c) from the spectral characteristics, determine that at least a portion of the electromagnetic radiation emitted in process chamber is caused by a chemical reaction of the chamber cleaning species with the coating or with at least one of the one or more components of the process chamber.

In another aspect of the present disclosure, a method of detecting clean endpoint is disclosed. In some embodiments, the method includes: (a) introducing a chamber cleaning species to a process chamber to remove a coating from one or more components of the process chamber without excitation or generation of a plasma within the process chamber; (b) generating a reference plasma; (c) detecting spectral characteristics of electromagnetic radiation emitted by one or more species excited by the reference plasma in the process chamber, and (d) from the spectral characteristics, determining that the coating has been removed from at least one of one or more components of the process chamber.

In another aspect of the present disclosure, a semiconductor manufacturing apparatus is disclosed. In some embodiments, the semiconductor manufacturing apparatus includes: a process chamber; at least one sensor having access to the process chamber; and a controller communicatively coupled to the at least one sensor, the controller configured to: (a) expose the process chamber to fluorine and/or a fluorine-containing species; (b) purge the process chamber one or more times; (c) generate a reference plasma in the process chamber; (d) detect spectral characteristics of electromagnetic radiation emitted from species excited by the reference plasma in the process chamber; (e) from the spectral characteristics, determine that a hazardous species is not present in the process chamber; and (f) based on determining that the hazardous species is not present in the process chamber, perform no further purges of the process chamber.

In another aspect of the present disclosure, an apparatus for monitoring and controlling a semiconductor device manufacturing equipment is disclosed. In some embodiments, the apparatus includes: at least one spectral sensor; and a controller communicatively coupled to the at least one sensor, the controller configured to: detect, using the at least one spectral sensor, spectral characteristics of emissions from within an internal portion of the semiconductor device manufacturing equipment; and responsive to a determination that a desired process condition within the internal portion has not been met based on the detected spectral characteristics, adjust a process associated with the semiconductor device manufacturing equipment toward the desired process condition.

In another aspect of the present disclosure, a method of detecting limited spectral signals within a process chamber of semiconductor device manufacturing equipment is disclosed. In some embodiments, the method includes: (a) in a process chamber containing a first chemical species used in a process without plasma, generating a reference plasma; (b) detecting spectral characteristics of light emitted by one or more species excited by the reference plasma in the process chamber; and (c) from the spectral characteristics, determining that the first chemical species is present in the process chamber.

In another aspect of the present disclosure, a method of indirectly determining a chamber state of a process chamber is disclosed. In some embodiments, the method includes: (a) in a process chamber comprising a first chamber state, generating a plasma, wherein the first chamber state influences the plasma in a manner that plasma exhibits a first plasma state; (b) measuring a value of a light property at a first spectral feature of a species in the process chamber, wherein the first spectral feature is sensitive to the first plasma state; and (c) from the value of the light property, determining that the first chamber state is present in the process chamber.

These and other features of the disclosed embodiments will be described in detail below with reference to the associated drawings.

### BRIEF DESCRIPTION OF DRAWINGS

FIG. 1A shows a fabrication tool for depositing or etching a film on or over a substrate utilizing a plasma process; the tool includes a spectral sensor.

FIG. 1B presents a schematic view of an implementation of a multi-station processing tool; the tool includes four camera sensors.

FIG. 1C presents a top view of an electronic device fabrication system having four multi-station fabrication tools, one of which includes camera sensors.

FIG. 2A schematically depicts an example implementation of such a spectral sensor with a process chamber or station.

FIG. 2B is a schematic view of an example spectral sensor, according to some embodiments.

FIG. 3 is example spectra obtained using spectral sensing, which depicts spectral signals obtained over time with respect to wavelength.

FIGS. 4A and 4B are flow diagram illustrating methods for monitoring and controlling a semiconductor device manufacturing equipment, according to some embodiments.

FIG. 5 shows a graph comparing signals obtained via spectral sensing and infrared-based signals.

FIG. 6 is a flow diagram illustrating a method for detecting clean endpoint, according to some embodiments.

FIG. 7 is a flow diagram illustrating another method for detecting clean endpoint, according to some embodiments.

FIG. 8A is an example spectral diagram indicating peaks corresponding to contamination by hazardous substance across a number of purge cycles.

FIG. 8B is an example graph relating to FIG. 8A, indicating the contamination-related signals over the number of purge cycles.

FIG. 9 is a flow diagram illustrating another method to determine an optimal number of purge cycles for a semiconductor device manufacturing apparatus, according to some embodiments.

FIG. 10A is an example spectral graph indicative of the presence of different gas species.

FIG. 10B is a graph relating to FIG. 10A, illustrating a change in intensity of signal intensities over time.

FIGS. 11A and 11B are flow diagrams illustrating methods of detecting limited-magnitude spectral signals within a process chamber of semiconductor device manufacturing equipment, according to some embodiments.

FIG. 12 is a is a flow diagram illustrating another method of indirectly determining a chamber condition of a process chamber of semiconductor device manufacturing equipment, according to some embodiments.

FIG. 13 shows a schematic diagram of components of a computing device that is implemented in a computing system in accordance with some implementations.

### DETAILED DESCRIPTION

This disclosure relates to characterization of semiconductor equipment, such as multi-station process chambers. The current approach for sensing and monitoring the state of semiconductor equipment typically involves employing a sensor for a respective task or class of tasks. The measurements obtained from individual sensors are used in isolation to obtain or infer indications of one or more characteristics relating to the equipment. In some cases, expert judgement is used to determine the characteristics based on experience or intuition or based on results obtained from other sensors or techniques. That is, a human element may be needed with sensing techniques to derive meaningful data in some cases.

In some typical scenarios relating to process engineering, process performance checks are performed by, e.g., visually verifying how plasma behaves a certain way when viewed through a viewport, based on sensor response to one of hundreds of correlated channels, or (most often) through performance on a substrate (e.g., a 300-mm wafer) after process is completed. These approaches do not provide an instantaneous response. Engineers do not always have time to check the plasma for each recipe or recipe step, and subtle system drifts may not be easily comprehended by visual inspection in fast changing systems, as plasma dynamics are in the order of microseconds (μs) to milliseconds (ms). Constant monitoring of correlated channels is not feasible without automated systems, and subtle changes may either not be captured with the current implementations of sensors or may be deemed as noise in the system. The most reliable (and most frequently used) indicator of process change is the impact a certain recipe has after process. Post-process metrology indicates whether a system state has changed, using the response of properties on the wafer (deposited film thickness, refractive index (RI), etc.). However, not all wafers are measured after process. These sensing inefficiencies can result in yield impact or wafer scrap and does not make real-time control feasible.

In some typical scenarios relating to clean endpoint (i.e., endpoint of a chamber clean), endpoint detection relies on either timed cleans (which does not account for system or process variability and/or changing accumulation based on differing processes) or using a narrow band absorption technique such as infrared endpoint detection (IR-EPD). IR-EPD looks for a certain voltage and slope of the signal or other indication of absorption and adds an overetch step. The overetch step may result in significant etching in some regions of the stations, reducing the lifetime of pedestal, e.g., because of aluminum fluoride (AlF₃) formation. Another method of endpoint detection in chamber clean involves using visual signal, e.g., using a camera. Such visual-based detection is limited to visible regions, however, and accurately determining which region cleans the slowest or is the last part requires extensive validation.

Thus, a sensing approach that can acquire and provide consistently accurate signals in an automated manner to provide a better understanding of the state of the equipment system as well as provide control opportunities is desired.

The following terms are used throughout the present specification:

“Manufacturing equipment” refers to equipment in which a manufacturing process takes place. Manufacturing equipment often has a process chamber in which the workpiece resides during processing. Typically, when in use, manufacturing equipment performs one or more semiconductor device fabrication operations. Examples of manufacturing equipment for semiconductor device fabrication include deposition reactors such as electroplating cells, physical vapor deposition reactors, chemical vapor deposition reactors, and atomic layer deposition reactors, and subtractive process reactors such as dry etch reactors (e.g., chemical and/or physical etch reactors), wet etch reactors, and ashers. In some embodiments, the manufacturing equipment may be a multi-station process chamber having, e.g., four stations.

As referred to herein, manufacturing equipment is sometimes simply referred to as a “process chamber.” In various embodiments, a process chamber is typically a sealed enclosure in which a substrate is immobilized during processing. The process chamber may include components associated with delivery of and removal of gases. It may also include components associated with generating a plasma and controlling properties of the plasma within the chamber. It may include components for controlling the pressure, including pulling a vacuum within the chamber. In the context of this disclosure, the process chamber may include a pedestal on which the substrate sits while it is being processed. A pedestal may be outfitted with a chuck such as an electrostatic chuck to hold the substrate in position during processing.

A “semiconductor device fabrication operation” as used herein is an operation performed during fabrication of semiconductor devices. As referred to herein, such a fabrication operation is sometimes simply referred to as a “process” or as “processing.” Examples of processing include deposition of a material on a substrate, selectively etching material from a substrate, and ashing of photoresist on a substrate. Typically, the overall fabrication process includes multiple semiconductor device fabrication operations, each performed in its own semiconductor fabrication tool such as a plasma reactor, an electroplating cell, a chemical mechanical planarization tool, a wet etch tool, and the like. Categories of semiconductor device fabrication operations include subtractive processes, such as etch processes and planarization processes, and material additive processes, such as deposition processes (e.g., physical vapor deposition, chemical vapor deposition, atomic layer deposition, electrochemical deposition, electroless deposition). In the context of etch processes, a substrate etch process includes processes that etch a mask layer or, more generally, processes that etch any layer of material previously deposited on and/or otherwise residing on a substrate surface. Such an etch process may etch a stack of layers in the substrate.

The terms “semiconductor wafer,” “wafer,” “substrate,” “wafer substrate” and “partially fabricated integrated circuit” may be used interchangeably. Those of ordinary skill in the art understand that the term “partially fabricated integrated circuit” can refer to a semiconductor wafer during any of many stages of integrated circuit fabrication thereon. A wafer or substrate used in the semiconductor device industry typically has a diameter of 200 mm, or 300 mm, or 450 mm. Besides semiconductor wafers, other work pieces that may take advantage of the disclosed embodiments include various articles such as printed circuit boards, magnetic recording media, magnetic recording sensors, mirrors, optical elements, display devices or components such as backplanes for pixelated display devices, flat-panel displays, micro-mechanical devices and the like. The work piece may be of various shapes, sizes, and materials.

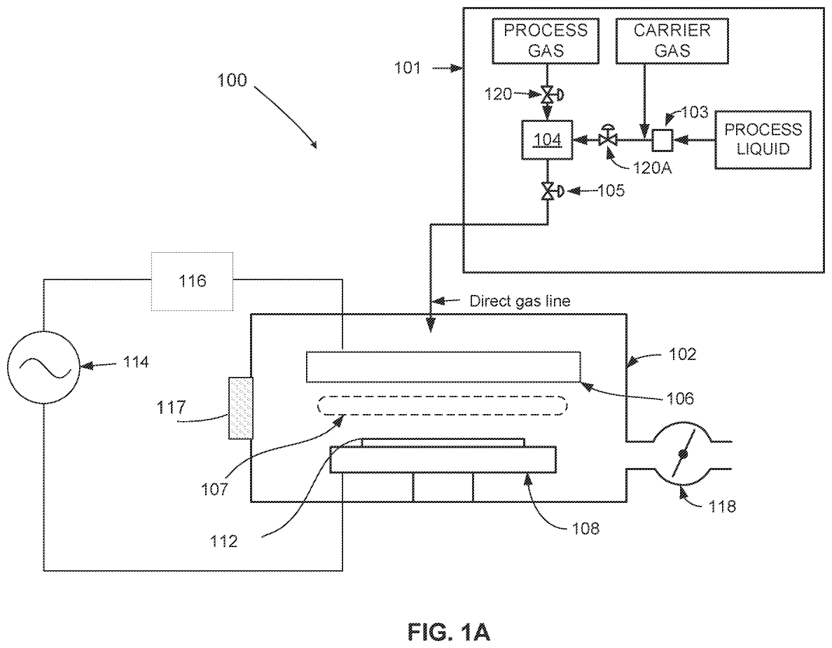

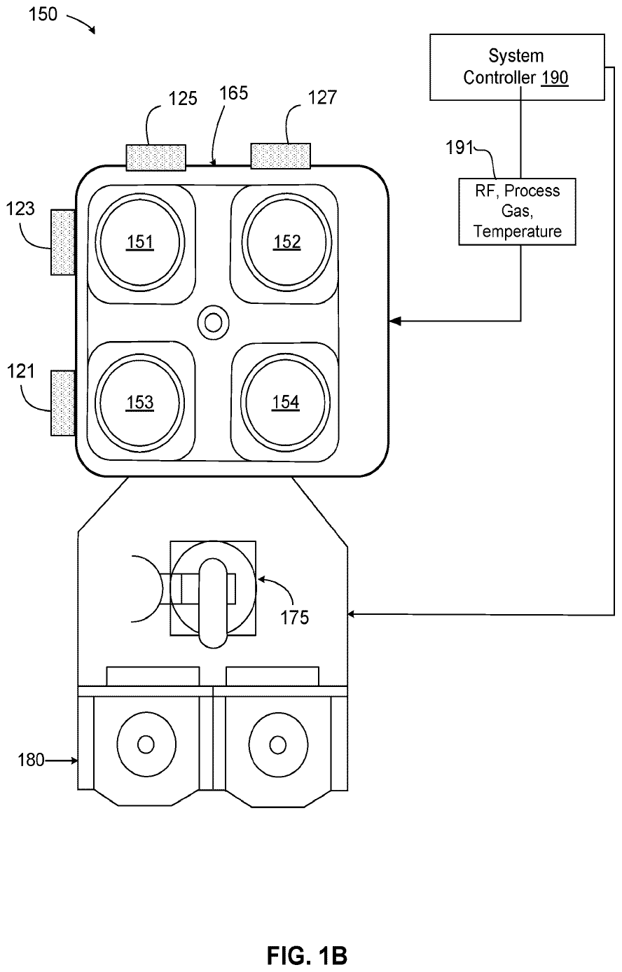

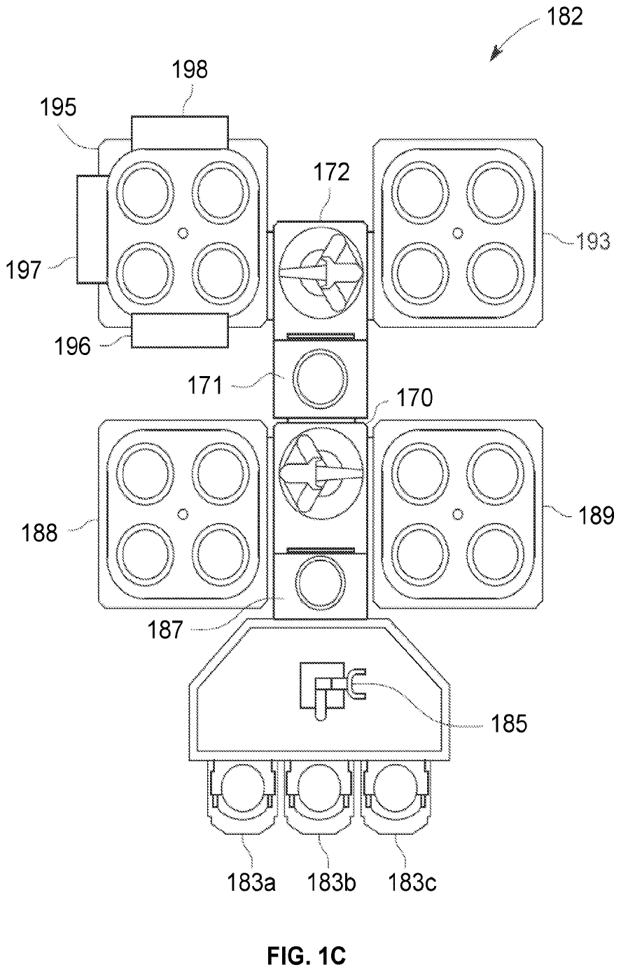

FIG. 1A shows a fabrication tool denoted as substrate processing apparatus 100. In various embodiments, substrate processing apparatus 100 may be configured to deposit films on or over a semiconductor substrate utilizing any number of processes. For example, substrate processing apparatus 100 may be configured to perform plasma-enhanced chemical vapor deposition (PECVD) or plasma-enhanced atomic layer deposition (PEALD). In various embodiments of the present disclosure, multiple sensors such as two or more of at least one spatial sensor (e.g., camera), at least one spectral sensor (e.g., optical emission spectrometry (OES) sensor), and/or at least one temporal sensor (e.g., photodiode) are implemented in one integrated sensor “package” or sensor system, which can be used for varying use applications and tasks in semiconductor systems such as fabrication tools that may include one or more process chambers and/or stations (e.g., multi-station fabrication tool 150 of FIG. 1B, fabrication system 182 of FIG. 1C). Such sensors may be positioned or otherwise configured to sense a plasma or monitor conditions in situ (without removing a wafer from the processing chamber to a separate metrology chamber after the processing to sense or monitor) and in real time (i.e., while the process is being performed on the wafer and on a time scale comparable to that of events occurring in the process chamber).

Substrate processing apparatus 100 may include one or more sensors or sensor packages 117 on a chamber wall. A given sensor may be implemented as a type of sensor, such as a spectral sensor of the type that will be described further below. When implemented as a sensor package, element 117 may include two or more different sensors, which in certain embodiments may be different types of sensors. In certain embodiments, the sensors include two or three of the following sensor types: spatial, spectral, and temporal. Sensor(s) or sensor package(s) 117 may be configured to capture image data from the interior of apparatus 100. Note that while sensor(s) or sensor package(s) 117 is shown as a single block, it represents implementations in which one, two, or more sensors are located proximate to one another, optionally sharing a single viewport or other window. In some cases, the individual sensors within block representing the sensor or sensor package 117 are trained on different components or fields of vision within a chamber interior. In some cases, the individual sensors within block 117 may be configured to capture different respective spectral ranges (far IR, near IR, visible, UV, etc.).

Substrate processing apparatus 100 of FIG. 1A may employ a single process station 102 of a process chamber with a single substrate holder 108 (e.g., a pedestal) in an interior volume, which may be maintained under vacuum by a vacuum pump 118. A showerhead 106 and a gas delivery system 101, which are fluidically coupled to the process chamber, may permit the delivery of film precursors, for example, as well as carrier and/or purge and/or process gases, secondary reactants, etc.

In FIG. 1A, a gas delivery system 101 may include a mixing vessel 104 for blending and/or conditioning process gases for delivery to showerhead 106. One or more mixing vessel inlet valves 120 may control introduction of process gases to mixing vessel 104. Particular reactants may be stored in liquid form prior to vaporization and subsequent delivery to process station 102 of a process chamber. The implementation of FIG. 1A may include a vaporization point 103 for vaporizing liquid reactant to be supplied to mixing vessel 104. In some implementations, vaporization point 103 may include a heated liquid injection module. In some other implementations, vaporization point 103 may include a heated vaporizer. In yet other implementations, vaporization point 103 may be eliminated from the process station. In some implementations, a liquid flow controller upstream of vaporization point 103 may be provided for controlling a mass flow of liquid for vaporization and delivery to process station 102.

Showerhead 106 may operate to distribute process gases and/or reactants (e.g., film precursors) toward a substrate 112 at the process station, the flow of which may be controlled by one or more valves upstream from the showerhead (e.g., valves 120, 120A, 105). In the implementation depicted in FIG. 1A, substrate 112 is depicted as located beneath showerhead 106, and is shown resting on a pedestal 108. Showerhead 106 may include any suitable shape and may include any suitable number and arrangement of ports for distributing process gases to substrate 112. In some implementations involving two or more stations, gas delivery system 101 may include valves or other flow control structures upstream from the showerhead, which can independently control the flow of process gases and/or reactants to each station so as to permit gas flow to one station while prohibiting gas flow to a second station. Furthermore, gas delivery system 101 may be configured to independently control process gases and/or reactants delivered to each station in a multi-station apparatus such that the gas composition provided to different stations is different; e.g., the partial pressure of a gas component may vary between stations at the same time.

In the implementation of FIG. 1A, gas volume 107 is depicted as being located beneath showerhead 106. In some implementations, pedestal 108 may be raised or lowered to expose substrate 112 to gas volume 107 and/or to vary the size of gas volume 107. The separation between pedestal 108 and showerhead 106 is sometimes referred to as a “gap.” Optionally, pedestal 108 may be lowered and/or raised during portions of the deposition process to modulate process pressure, reactant concentration, etc., within gas volume 107. Showerhead 106 and pedestal 108 are depicted as being electrically coupled to an RF signal generator 114 and a matching network 116 for coupling power to a plasma generator. Thus, showerhead 106 may function as an electrode for coupling radio frequency power into process station 102. RF signal generator 114 and matching network 116 may be operated at any suitable RF power level, which may operate to form plasma having a desired composition of radical species, ions, and electrons. In addition, RF signal generator 114 may provide RF power having more than one frequency component, such as a low-frequency component (e.g., less than about 2 MHz) as well as a high frequency component (e.g., greater than about 2 MHz). In some implementations, plasma ignition and maintenance conditions may be controlled with appropriate hardware and/or appropriate machine-readable instructions in a system controller which may provide control instructions via a sequence of input/output control instructions. However, in some cases, plasma ignition in the chamber need not be performed. In some such cases, species in a process chamber may be electrically excited but not necessarily in a plasma state. For example, as will become relevant below, during chamber cleans, light generated from radicals or excited species based on a remote plasma source may be used.

In general, the disclosed embodiments may be implemented with any plasma-assisted fabrication tool, including integration of sensors (including, e.g., sensor(s) or sensor package(s) 117) configured to acquire data (including, e.g., images) relating to plasmas and/or plasma-related phenomena. Example deposition apparatus include, but are not limited to, apparatus from the ALTUS® product family, the VECTOR® product family, and/or the SPEED® product family, the KIYO® product family, the STRIKER® product family, and the VERSYS® product family, each available from Lam Research Corp. of Fremont, Calif., or any of a variety of other fabrication tools employing plasma.

In addition, in some embodiments, the sensors or sensor packages as described herein may be capable of serving multiple purposes. As one example, a spectral sensor or sensors may collect spectral information that can be used for one or more of multiple use applications such as those that will be described below, depending on the scenario. As one example, a sensors or sensor package may be or include a hyperspectral sensor (which is configured to capture intensity values in numerous narrow wavelength bins) or a multispectral sensor (which is configured to capture intensity values over broader wavelength bins, typically fewer than the numerous narrower bands of hyperspectral sensing). A hyperspectral or multispectral sensor may thereby provide both spatial and spectral sensor information, where the spectral information may correspond to wavelengths within or outside of the visible spectrum (e.g., at least a portion of the ultraviolet (UV) spectrum, at least a portion of the infrared (IR) spectrum).

For simplicity, processing apparatus 100 is depicted in FIG. 1A as a standalone station 102 of a process chamber for maintaining a low-pressure environment. However, some fabrication tools employ a plurality of process stations such as those shown in FIG. 1B.

Referring to FIG. 1B, an implementation of a multi-station fabrication tool 150 is depicted, according to some embodiments. In some embodiments, multi-station fabrication tool 150 may employ a process chamber 165 that includes multiple fabrication process stations, each of which may be used to perform processing operations on a substrate held in a wafer holder, such as pedestal 108 of FIG. 1A, at a particular process station. In the implementation of FIG. 1B, the process chamber 165 is shown as having four process stations 151, 152, 153 and 154. However, in certain other implementations, multi-station processing apparatuses may have more or fewer process stations depending on the implementation and, for instance, the desired level of parallel wafer processing, size or space constraints, or cost constraints. FIG. 1B additionally shows a substrate handler robot 175, which may operate under the control of a system controller 190. The substrate handler robot 175 may be configured to move a substrate from a wafer cassette (not shown in FIG. 1B) from a loading port 180 and into the multi-station process chamber 165 and onto one of process stations 151, 152, 153 or 154.

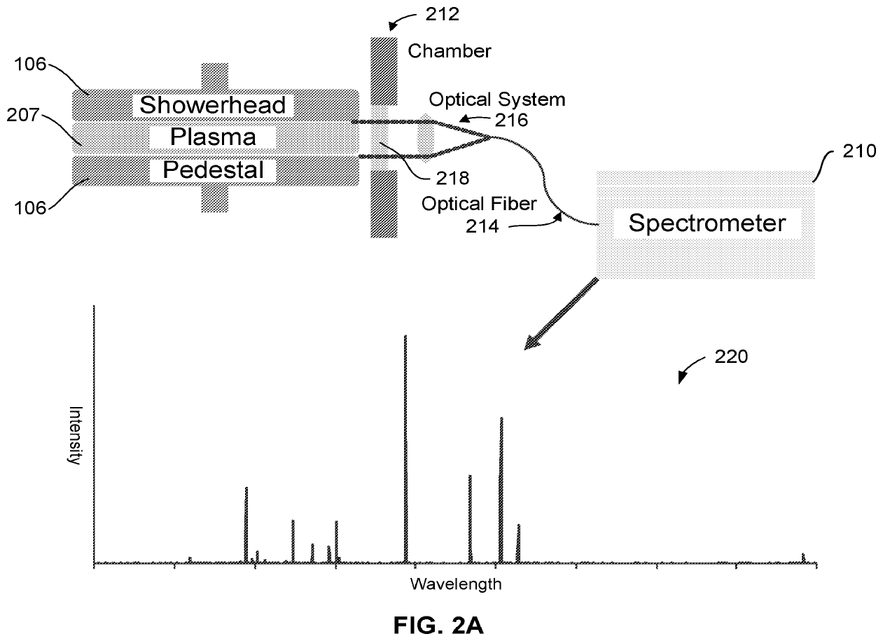

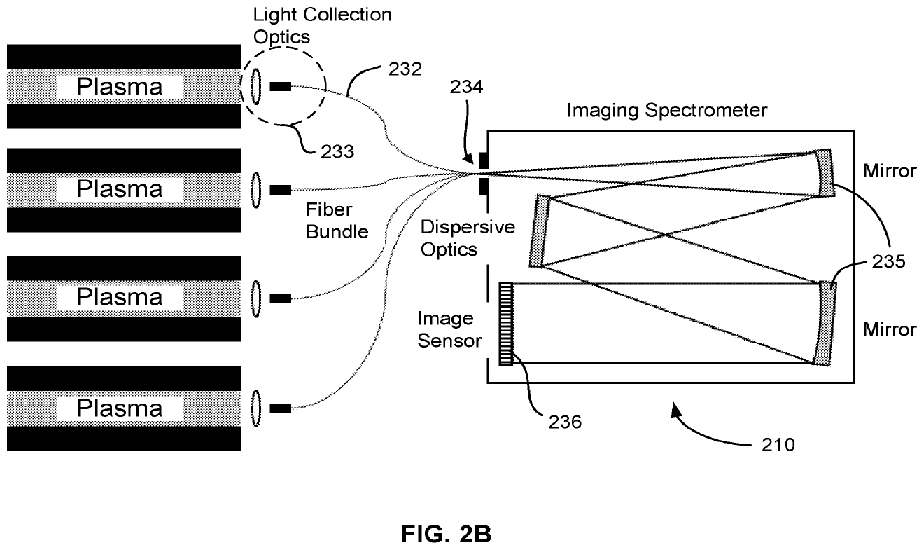

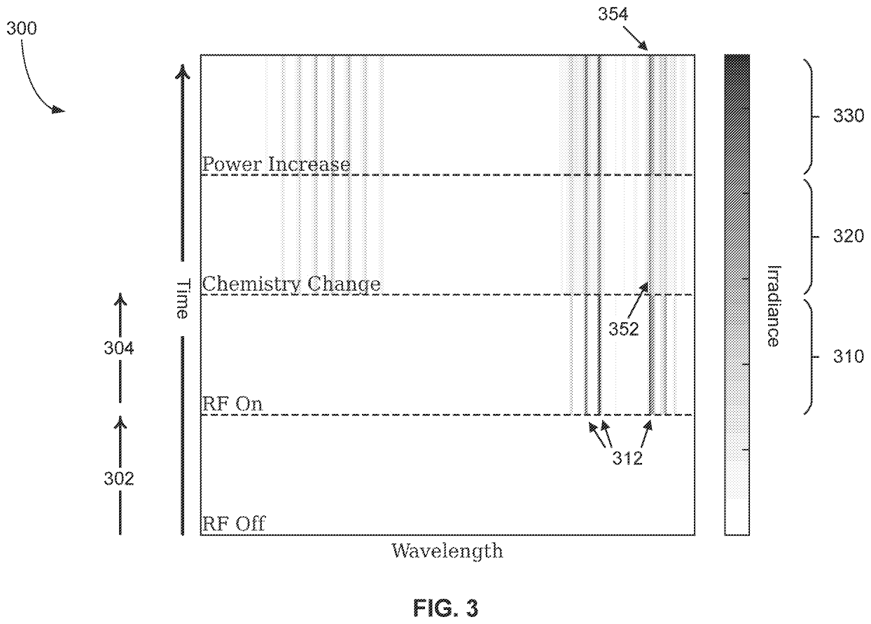

As depicted in FIG. 1B, process station 153 has an associated sensor or sensor package 121 located and configured to obtain in situ information (e.g., image, spectral, and/or temporal data) from within process station 153 and, in some embodiments, from within process chamber 154. Process station 151 may have two associated sensors or sensor packages 123 and 125. Sensor or sensor package 123 is located and configured to obtain in situ information from within process station 151 and, in some embodiments, from within process chamber 152. Sensor or sensor package 125 is located and configured to obtain in situ information from within process station 151 and, in some embodiments, from within process chamber 153. Process station 152 may have an associated sensor or sensor package 127 located and configured to obtain in situ information from within process station 152 and, in some embodiments, from within process chamber 154. When implemented as a sensor package, elements 121, 123, 125, 127 may include two or more different sensors, which may be different types of sensors. Any one or more of sensors or sensor packages 121, 123, 125 or 127 may be coupled to the interior of process chamber 165 via a viewport or other window disposed in the chamber wall. Additionally, while not shown in FIG. 1B, some embodiments may include one or more sensors or sensor package adjacent to the process station 154. Example positioning of sensors or sensor packages will be described further with respect to FIGS. 2 and 3 below.

In the context of the present disclosure, the terms precision, stability, and matching may refer to the sigma (σ, standard deviation) of a process metric (measurement result) reported by the sensor or sensor package in high volume manufacturing (HVM). Ostensibly, the same process is measured repeatedly and over extended periods of time with multiple copies of the sensor or sensor package (the measurement equipment). The same sensor package may be installed at multiple stations within a process module, and at multiple process modules, with process modules installed on multiple tools possibly at multiple HVM lines in different locations. These in-line HVM process metrics from the sensor or sensor package can be used to develop correlations with other HVM process metrics including those acquired using precision off-line specialized metrology techniques. Such correlations may then enable near real-time process optimization and root-cause analysis of process deviations.

Measurement results or metrics may be recorded by a host device (e.g., computing device) receiving the data. Precision may be defined as the sigma of a metric repeated over the shortest possible time under nearly identical conditions. Precision may quantify or represent the fundamental limit of a metric, and generally requires more than 10 input values of the metric to be used to calculate the sigma where the values are acquired in rapid sequence, without unnecessary interruption. Stability may be defined as the sigma of a metric reported over a defined time period. Stability may quantify or represent a process study or a gage study (indicating repeatability and reproducibility of measurements), which typically occurs over multiple days, such as over the lifetime of a process kit. Process stability and gage stability may not be easily separable in the data for many metrics. Prudent use of stability results across multiple metrics can help identify gage drift from process drift. High stability is beneficial because predictive maintenance and process throughput improvements must be based on metrics with known stability. Matching may be defined as the sigma of a metric over multiple sensors or sensor packages acquired over multiple days (stability data sets of sensor sub-systems). One example of matching is within a single process module (PM) containing multiple sensor sub-systems. In particular, in intra-PM matching, multiple sub-systems on a single PM can be used to quantify the metric's PM matching sigma. With inter-PM matching, matching may be measured, e.g., within a fabrication tool, across fabrication tools, or across installed base at multiple sites. Sub-system (e.g., of a sensor or sensor package) specific control limits can be used to manage matching nonidealities, but this approach is cumbersome. Metrics that well match across well-functioning sub-systems are preferred. Generally, process precision is easiest (single chamber, short time), process stability is harder to achieve (because of, e.g., drift over time), and chamber-to-chamber or tool-to-tool process variation is the hardest.

In some implementations, the sensor or sensor package may report metrics to the host device as a function of time. This data can be further refined to define customized metrics by the end user of the sensor or sensor package. The precision, stability and matching of metrics help define the limits of the sensor package to manage the underlying process. In the end, process precision, process stability and process matching are desirable for the sensor or sensor package, e.g., using it to develop process metrology techniques, perform process quality control (e.g., establishing whether a behavior is normal, whether abnormal behavior is an impulse or a drift issue, whether a behavior warrants corrective action), and establish process tolerance limits for metrics end users find to be important.

In some embodiments, fabrication tool 150 may include the system controller 190 configured to control process conditions and hardware states of the fabrication tool 150. In some embodiments, the system controller 190 may interact with one or more sensors, gas flow subsystems, temperature subsystems, and/or plasma subsystems—collectively represented as a block representing subsystems 191—to control process gas flow, thermal conditions, and/or plasma conditions as appropriate for controlling a fabrication process. In various implementations, the system controller 190 and the subsystems 191 may act to implement a recipe or other process conditions in one or more of the process stations (e.g., 151-154) of the process chamber 165. A system controller may be fully located on or in close proximity to a fabrication tool (e.g., as an edge computer in manufacturing equipment), or a system controller may be fully located remote from the fabrication tool (e.g., on a hosted cloud computing resource), or a system controller may be partially located on manufacturing equipment and partially located remotely.

In multi-station fabrication tools, an RF signal generator may be coupled to an RF signal distribution unit, which is configured to divide the power of the input signal into, for example, four output signals. Output signals from an RF signal distribution unit may possess similar levels of RF voltage and RF current, which may be conveyed to individual process stations (e.g., 151-154) of a multi-station fabrication tool.

FIG. 1C provides a top view of an electronic device fabrication system 182 having four quad-station fabrication tools 188, 189, 193 and 195. Quad-station fabrication tools 188, 189, 193 and 195 may be examples of stations 151-154 of FIG. 1B. Each quad-station tool contains four process stations, each configured to hold and process a substrate. At the front end of the electronic device fabrication system 182 are three front opening unified pods (FOUPs) 183a, 183b and 183c accessible by a front-end wafer handling robot 185, which is configured to transfer wafers between the FOUPs and a first load lock 187. A first wafer handler 170 may be located and configured to transfer wafers between the first load lock 187 and quad-station fabrication tools 188 and 189. The first wafer handler 170 may also configured be to transfer wafers to a second load lock 171 which makes wafer available to quad-station fabrication tools 193 and 195 via a second wafer handler 172.

In some embodiments, the quad-station tool 195 (as an example) may include three sensors or sensor packages 196, 197 and 198 disposed around its outer wall. In FIG. 1C, the sensors or sensor package 196-198 are shown vertically affixed to three sides of the four-sided chamber of tool 195. In the embodiment shown, the only side without a sensor or sensor package is the side next to the wafer handler 172. While not shown in FIG. 1C, similar sensor or sensor package arrangements can be provided on any one or more of each of the three other quad station chambers 188, 189 or 193 in the system. Further, in some implementations, a sensor or sensor package may still be placed on the side next to the wafer handler 172. Myriad other positioning of one or more sensors (including combinations of sensors together or separately in a sensor package) are possible depending on, e.g., the measurements, angles, locations to measure desired. It should be understood that, in some cases, a system controller (e.g., 190 of FIG. 1B) may be configured to modify a position or orientation of a given sensor or sensor package (e.g., up, down, left, right, diagonal, azimuthal, elevational).

### Spectral Sensor Configurations

A spectral sensor provides wavelength-specific radiation intensity detection. It outputs values of radiation intensity as a function of wavelength or spectral region. A spectral sensor has various capabilities. The information it provides may discriminate among, or identify, particular chemical species; each chemical species has its own particular spectrum. In some implementations, a spectral sensor can discriminate among signal from wavelengths in one or more regions of the electromagnetic spectrum including UV, visible, and IR.

A spectral sensor may be implemented in various ways. Examples of wavelength separation components include (a) dispersive devices (these separate wavelengths in a dispersive medium such as a prism), (b) diffractive device (these separate wavelengths by diffraction using, e.g., a diffraction grating), (c) filters disposed in front of intensity detector so that the detector receives only certain wavelengths of interest.

One example of a spectral sensor detector is a linear array of optical detectors configured to detect wavelength-specific intensities at different detectors in the linear array. An optical detector may be configured to provide an output of intensity as a function of wavelength. A wavelength separation component disposed in front of a linear array provides wavelength separation in one dimension (along the linear array), so that each element of the linear detector is associated with a particular wavelength or a range of wavelengths.

Unlike a spatial sensor, a spectral sensor need not provide multi-dimensional images. Additionally, for some applications the speed at which a spectral sensor acquires data need not be fast (e.g., ≥1 ms capture rate or about 1 ms-1 s).

FIG. 2A is a depiction of an example implementation of such a spectral sensor 210 with a process chamber (e.g., 165, 182) or station (e.g., 102, 151-154, 188, 189, 193, 195). Such a spectral sensor may also be referred to as a spectrometer, which is configured to separate and measure spectral components (e.g., wavelengths). The spectral sensor 210 may be coupled to a wall 212 of the chamber via an optical fiber 214, which may be coupled to an optical system 216. In some embodiments, the optical system 216 may include light collection optics (e.g., lens or other apparatus that focuses, disperses, or passes light) that receive light and/or spectral information via a viewport or other window 218. The light and/or spectral information may have been generated by processes within the chamber, presence of gases and other materials (e.g., on the interior side of a wall), reactions with plasma 207 or other materials present in the chamber, and so on. The collected light and/or spectral information may be transmitted via the optical fiber 214 and received by the spectral sensor 210. The spectral sensor 210 may then implemented as above to, e.g., separate components of the received light and/or spectral information. Spectrum 220 is an example of a spectrum that may be produced based on the detected components of the light and/or spectral information. As illustrated, the spectrum 220 may represent the intensity of wavelength components. Collectively, the foregoing may herein be referred to as spectral information or spectral characteristics, and include wavelengths, locations of spectral lines or bands (e.g., with respect to wavelength along a spectrum or spectral graph such as 220), intensities or magnitudes of the spectral lines or bands, and/or width of spectral lines or bands.

FIG. 2B is a diagram of an example spectral sensor 210, according to some embodiments. In some embodiments, the spectral sensor 210 may be implemented at least partially as, or at least as part of, e.g., an OES sensor or a spectral reflectometer, and in some cases may be referred to as a spectrometer. The spectral sensor 210 may be coupled to one or more transmission optical fibers 232. A transmission optical fiber 232 may be an example of the optical fiber 214 of FIG. 2A, and may collect spectral information from a corresponding process, e.g., at a process chamber or a station within a process chamber. For example, a transmission optical fiber 232 may receive spectral information via light collection optics 233 during a process from a process station of a multi-station process chamber (e.g., of the type described with respect to FIGS. 1B and 1C). The light collection optics 233 may be an example of the optical system 216 of FIG. 2A. In some implementations, the light collection optics 233 may include a lens or similar apparatus and/or a terminal portion of the optical fiber 232. In some embodiments, each of the four optical fibers 232 is associated with its own process station and collects optical signals emitted from its process station. As shown in FIG. 2B, the spectral sensor 210 may receive spatial information from four stations of a four-station process chamber via four transmission optical fibers 232, as one example implementation. Four process stations and four optical fibers 232 are depicted in FIG. 2B, but any number of process stations and optical fibers may be implemented, and more than one optical fiber may be implemented for a given process station (e.g., two or more optical fibers coupled to different surfaces or walls of a process station). At least some of the transmission optical fibers 232 may be grouped and received by the spectral sensor 210 via at least one inlet 234 associated with the spectral sensor 210.

In some embodiments, the spectral sensor 210 may further include dispersive optics such as one or more mirrors 235, some or all of which may have optical dispersion properties from being coated with varying depths so that different wavelengths have different penetration lengths, allowing a mirror 235 to reflect varying wavelengths of light. In some embodiments, as noted above, dispersive optics may include diffractive devices and/or filters, as well as other dispersive devices (e.g., prism). The spectral sensor 210 may include an image sensor 236 that detects the spatial information, which may include spectrally separated light components. For instance, the spatial information may indicate that wavelength A has a magnitude of X and that wavelength B has a magnitude of Y and so on for other separated wavelengths and their individual magnitudes.

In certain embodiments, an optical detector (e.g., image sensor 236) for a spectral sensor is a linear, one-dimensional array or a two-dimensional array of detector devices. As an example, a spectral sensor is a two-dimensional charge couple device (2D CCD) array where spectrally separated light components are detected by different regions of the 2D CCD. In some implementations, a linear array of detectors that separately detect wavelength-specific intensities at different detectors in the linear array may be used. Refraction (e.g., a prism) or diffraction (e.g., a grating) may be employed for wavelength separation in one dimension along the linear array. Each element of the linear detector may be associated with a particular wavelength or a range of wavelengths. Various implementations may be employed for different use cases. In some embodiments, a spectral sensor for capturing spectral information about a plasma may be capable of sensing intensity values of electromagnetic radiation of, and/or discriminating among signals from, wavelengths including at least portions of the visible spectrum, at least portion of the ultraviolet (UV) spectrum, at least a portion of the infrared (IR) spectrum, or any combination thereof. In some cases, the optical detector does not need to provide a fast capture rate (e.g., more often than about every 1 ms or more). The optical detector may operate at a frame rate of, e.g., about every 1 ms to 1 second.

Myriad other implementations of the spectral sensor 210 are possible, including, for example, mounting the spectral sensor directly at the viewport, eliminating at least some of the transmission optical fibers 232, eliminating some or all of the light collection optics 233, switching between different optical inputs (e.g., fiber switch, microelectromechanical systems (MEMS) mirror), using a different type of dispersive optics configuration (e.g., gratings, prisms, computed tomography (CT), echelle grating), using a spectral filter (e.g., filter wheel, or in some cases etalon or tunable liquid crystal), using time-domain spectral analysis (e.g., in some cases, using an optical spectrum analyzer).

In some embodiments, a spectral reflectometer device may be used as a spectral sensor (as will be further described below). A reflectometer device may include a light source that is used to illuminate the surface in question, and an optical detector. The optical detector may include one or more photodetectors. A fiber optic cable may be connected to the spectral reflectometer device. The optical cable may include transmission optical fibers and receiving optical fibers, where each receiving optical fiber may be connected to a respective individual photodetector. In some cases, a plurality of receiving optical fibers may be connected to a same photodetector.

In some embodiments, the spectral sensor 210 may be a spectral reflectometer device, having its own light source associated therewith.

In some embodiments, phase-sensitive spectroscopic ellipsometry may be used. In some embodiments, reflectometry with polarization control may be used especially with structures that are highly polarizing.

Advantageously, spectral sensor intensity counts can be collected for a larger area as opposed to certain other types of sensors. For example, spatial information may be based on intensity collected by each pixel of a visible portion (e.g., interior of a process chamber) captured by a spatial sensor (e.g., camera).

In some embodiments, a single spectral sensor (e.g., an OES sensor) may be deployed on a single process chamber but may be configured for use in multiple applications. Examples of such applications include monitoring the fabrication process for which the chamber is designed, determining whether HF purge is complete, detecting a leak, detecting a chamber clean endpoint, and any combination thereof. Spectral information captured using the single spectral sensor may be used in different ways as will be detailed below depending on the scenario.

### Illumination Sources

In some cases, a fabrication tool may include a lighting system or one or more illumination sources configured to illuminate all or one or more portions of an interior of the fabrication tool. Note that in some cases no lighting system is employed and lighting is used from the plasma itself. In some implementations, a lighting system employs one or more light-emitting diodes (LEDs) or other light sources. The light sources may be monochromatic, polychromatic with discrete emission wavelengths, or broad spectrum. The light source may be active continuously, pulsed synchronously with one or more camera shutters, pulsed asynchronously with one or more camera shutters, or pulsed synchronously with other process parameters such as RF generators or gas delivery valves. In other implementations, multiple light sources are employed in different locations within or outside the chamber. These multiple light sources can be energized continuously or sequentially with timing managed to enable structured lighting to be utilized to construct super-resolution images of features within the chamber. In some implementations, one or more notch or bandpass filters are provided in front of a light source to produce effects that can support analysis (e.g., identification of particular chemical species by their emission spectra). In some implementations, strobe lighting and other structured lighting may be employed (e.g., using periodic bursts of illumination at, e.g., 10, 30, 60 Hz) to provide additional discrete visual information at a consistent frequency. Strobe lighting of particular wavelengths may support calibration of spectral sensors as well.

In certain implementations, illumination sources are used in conjunction with the various embodiments disclosed herein and their applications described below. Some examples include, but are not limited to, (i) measuring the reflectance of the LED off of internal surfaces to identify surface condition (e.g. coating presence and quality), (ii) calibrating the spectral sensor (as mentioned above in relation to strobe lighting), and (iii) absorption measurement for species in situ. Illumination sources may also be used to confirm that spectral sensors are functioning normally, to track system drift over time, and to determine if a sensor or illumination source is the source of system decay.

### Applications and Methods for Spectral Sensors

Spectral sensors in typical applications are characterized in part by conservative or narrow applications of processes. That is, a process may be applied for a preset duration without feedback. Spectral information may be collected using a spectral sensor to obtain information about a fabrication system or tool. For example, the spectral information may be monitored using a spectral sensor with a line of sight access to a process chamber. Post-process metrology may be performed to determine or obtain basic insights such as any changes to the system state.

Further, existing technologies for monitoring conditions within a process chamber typically work for only one application or for detecting only one species in the process chamber. For example, mass spectroscopy is often be used to detect trace gases. Mass spectrometers are sometimes limited to specific species, expensive, intrusive as they require integration in a vacuum system, and susceptible to contamination in chemically harsh environments. As another example, infrared endpoint detection (IREPD) can be used to detect a single chemical species associated with a process end point. Specifically, IREPD employs a filter designed to detect the light absorption of one specific species; it is not useful for the detection of species other than one chosen one. IREPD also requires an IR source light.

Some existing techniques miss localized events within a process chamber. For example, IREPD and some other known techniques sample gas in an exhaust line, where it is a mixture of gas from throughout the chamber and having been resident in the chamber over a variety of time durations.

On the other hand, spectral sensing can passively sense information to determine chamber conditions, plasma conditions, presence of gases, etc. Spectral sensing may also sense many species simultaneously at a low cost, and does not intrude on process volume (e.g., sensor can be placed outside of the process chamber, e.g., through a window). Moreover, spectral sensing has a high sensitivity, which is useful as some deposition processes are very sensitive to trace contaminants.

As an example, optical emission spectroscopy (OES) measures the spectral content of light or other emissions, e.g., from a process chamber. A spectrum (obtained using a spectral sensor) of a plasma generated within a deposition tool can be used to assess the plasma condition and/or chamber condition (as will be described below).

### Process Diagnostics

In one example aspect and application of spectral sensing according to embodiments described herein, spectral sensing (e.g., OES) can be used to monitor process conditions. Historically, such process conditions are not measured, or are measured through cumbersome manual or ad hoc procedures. Some existing techniques may involve limited measurements using, e.g., mass spectroscopy or IREPD. Spectral sensing, however, can be used passively for diagnostics and/or troubleshooting purposes, or as part of an active control loop.

Process diagnostics refers to the ability to know the state of the process conditions within the fabrication tool and to assess the tool's configuration. An example of process conditions includes the gases currently flowing into the process volume. Other examples of process conditions include presence of gases, time to introduce or purge gases from chamber volume, plasma active (on) or inactive (off) status, gas temperature, and plasma parameters. An example of tool configuration includes which gas line is connected to which valve.

The process conditions can be assessed through existing sensors, such as current and voltage probes, thermocouples, and pressure gauges. In some cases, understanding of process conditions can rely on expert knowledge, such as differentiating process gases based on the apparent color. For many quantities, however, the existing methods are insufficient. For example, assessment of process gas by observable color is a fundamentally subjective technique and can often not distinguish between gas mixtures. The tool configuration is also difficult to assess. For example, plumbing of process gases is a manual process which relies heavily on administrative controls. There are limited ways to confirm that the correct gas line is connect to the correct valve.

To these ends, a spectral sensor can be used to measure many parameters governing tool configuration and process conditions. Referring back to the example of tool configuration, spectral sensing (e.g., using OES) can be used to identify which gas lines are connected to which valves. In some approaches, each valve may be individually opened, and RF power may be applied with the chamber at a known gas pressure. The resulting spectral signature can be compared (either manually or computationally, e.g., matching wavelengths and intensities) to a reference library of lines, patterns, and/or full spectra for process gases of interest. In some cases, changes in the spectral response of the system due to accumulation or etching of the window may be corrected for through the use of a reference light source or plasma.

In some cases, process optimization may require an in situ measurement of the time required to introduce a new process gas or the time required to pump out a process gas from the chamber volume. This may be accomplished in an approach similar to the above: In some approaches, a plasma may be struck in a known gas at a known condition, and then the valve for the process gas in question may be either opened or closed. Spectral sensing, e.g., using an OES sensor, may then be used to track signatures (lines, spectral bands, etc.) of the gas in question in order to identify how long it takes for the gas to reach the process volume or to be pumped out of it. In some implementations, signatures may include dominant signatures having significant presence within the spectrum.

FIG. 3 illustrates example spectra 300 obtained using spectral sensing, which depicts spectral signals obtained over time with respect to wavelength. It can be seen that after some amount of time 302, plasma RF power is turned on for a period of time 304, during which time a spectral sensor may detect emissions from the plasma activation. The spectral sensor may separate components using implementations described with respect to FIGS. 2A-2B above. Using RF activation as an example, it can be seen that a corresponding spectral pattern 310 contains bands 312 of higher intensity within a certain wavelength range, with some dominant signatures of higher irradiance intensity. In some cases, the obtained spectral pattern 310 can be compared or mapped to a reference library of lines, patterns, and/or full spectra. In other words, if the spectral sensor obtains spectral pattern 310, it can be determined with some certainty or likelihood that plasma RF power is on. Chamber conditions such as the plasma-on status can therefore be determined based on this type of spectral sensing.

FIG. 3 illustrates additional spectral patterns 320, 330 corresponding to a chemistry change (e.g., gas flow) and power change. By comparing spectral patterns with, e.g., the reference library, these chamber conditions can similarly be mapped and determined using spectral sensing. While plasma RF is off, there is no spectral signature since no emissions are caused by this chamber condition. Based on presence or absence of spectral lines and intensities, it can be determined that certain chamber conditions exist or do not exist. As an example of spectral intensities, spectral lines 352 and 354 at a similar wavelength have different thicknesses and brightness. In some implementations, such differences can be determined by visual analysis (e.g., compare pixel intensities and quantities) to distinguish between different chamber conditions—in this case, a chemistry change (where line 352 is fainter than line 354) and power change (where line 354 is more prominent than line 352).

Furthermore, the spectra obtained (e.g., by OES) is a sensitive and complex measure of the process conditions. Specific process quantities, such as gas temperature, plasma temperature, and discharge mode are directly accessible through spectral information. Alternatively, the process health may be assessed either through comparison to a library of known good spectra, or through machine learning algorithms that identify correlations between spectral properties and on-wafer performance. An example of a machine learning model that may enable such identification include a model trained for logistical classification using labeled spectral patterns and loss minimization.

### Process Control

Process control refers to the active control of the deposition tool's conditions to obtain a desired on-wafer result. Typically, process control is accomplished through open-loop tool operation and ex situ measurements. For example, film properties (stress, thickness, uniformity, etc.) are measured on metrology tools and this information is used to iterate on the process conditions. However, this approach to process control is fundamentally slow (e.g., taking place over days) and has trouble adapting to slow drifts in tool performance.

In process diagnostics (described above), the use of spectral sensing (e.g., OES) was considered in a purely passive or diagnostic role to assess tool or plasma conditions. For process control, spectral sensing can be used as a component in an active control scheme. Because a spectrum (e.g., 300, 310) is strongly dependent on the conditions within the deposition system, spectral sensing can be used to determine relatively quickly (and directly) if the chamber is operating at the desired condition (with the desired temperature, density, etc.). If the plasma has drifted from the optimal process conditions, the process parameters can be iteratively adjusted to return the process to the desired state by comparison to a known good spectrum. In some implementations, this may involve repeated comparisons, which may add to a body of labeled data for further training of the aforementioned machine learning classification model. In some cases, the choice of how to adjust process parameters can be determined either through an empirical model of how each parameter impacts the spectral properties, a theoretical model of plasma performance, or a combination of the two.

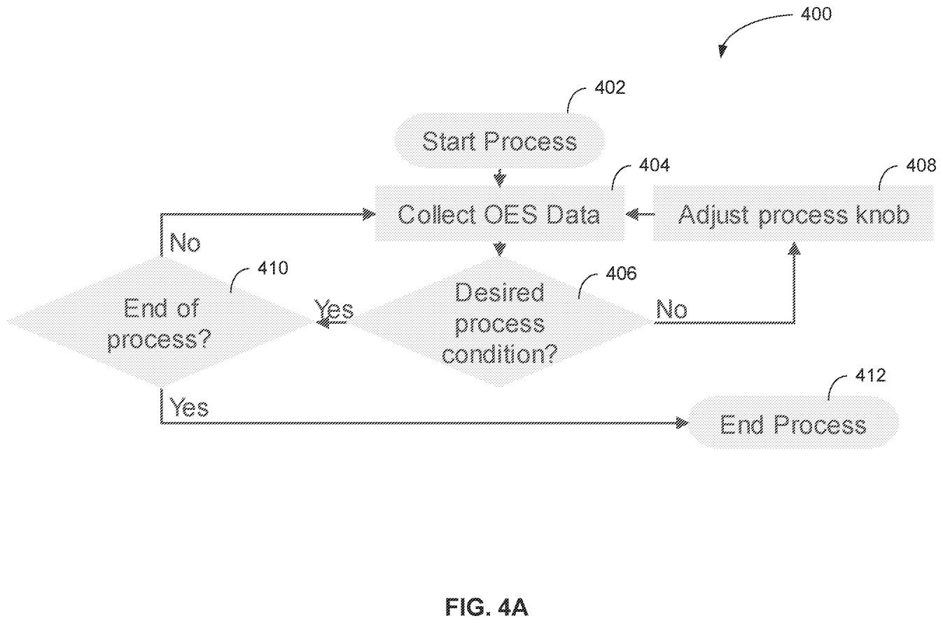

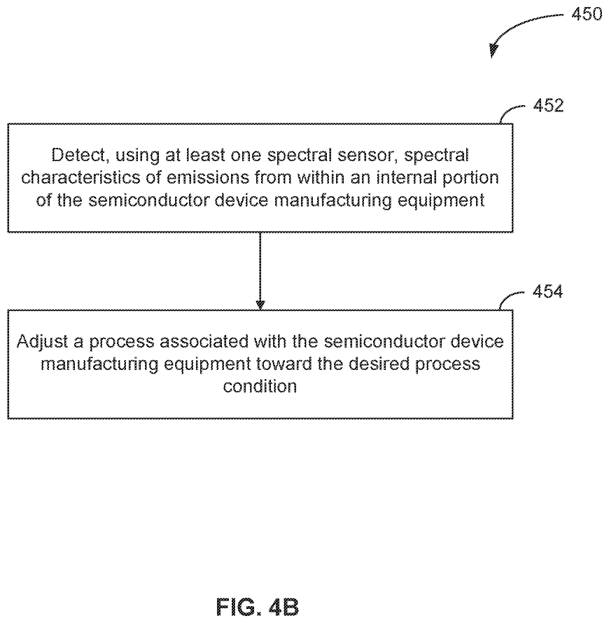

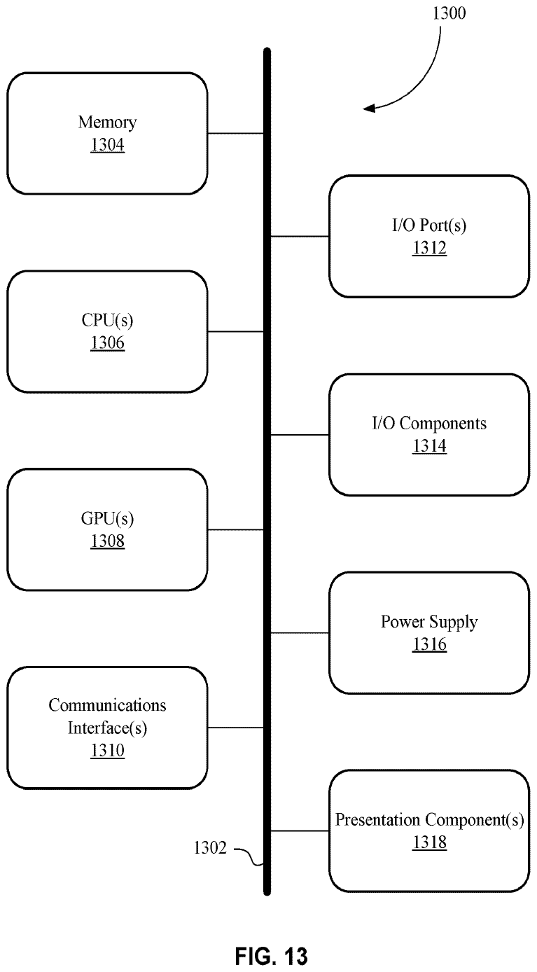

FIGS. 4A and 4B are flow diagram illustrating methods 400 and 450 for monitoring and controlling a semiconductor device manufacturing equipment, according to some embodiments. One or more of the functions of the methods 400 and 450 may be performed by or caused by a computerized apparatus or system. Structure for performing the functionality illustrated in one or more of the steps shown in FIGS. 4A and 4B may include hardware and/or software components of such computerized apparatus or system, such as, for example, a controller apparatus, a computerized system, or a computer-readable apparatus including a storage medium storing computer-readable and/or computer-executable instructions that are configured to, when executed by a processor apparatus, cause the at least one processor apparatus or a computerized apparatus to perform the operations. A controller may be one example of the computerized apparatus or system. The controller may be connected to a tool computer or an independent edge node that has similar components as the tool computer, but the logic and storage may be independent of the tool controller. A subsystem (e.g., 191) may be another example of the computerized apparatus or system. A process chamber may be another example of the computerized apparatus or system. Example components of a process chamber and a controller are illustrated in FIGS. 1A and 1B, and 13, respectively, and described in more detail elsewhere herein.

It should also be noted that the operations of the methods 400 and 450 may be performed in any suitable order, not necessarily the order depicted in FIGS. 4A and 4B. Further, the methods 400 and 450 may include additional or fewer operations than those depicted in FIGS. 4A and 4B to monitor and control the semiconductor device manufacturing equipment.

In some embodiments, the computerized apparatus or system may include at least one spectral sensor of a semiconductor device manufacturing apparatus.

Referring to FIG. 4A, at block 402, the method 400 may include starting a process. In some scenarios, the process may include a deposition process, such as introducing a gas into a process chamber and/or depositing a material (e.g., film) on a substrate.

At block 404, the method 400 may include collecting spectral data. In some embodiments, spectral data may be collected using at least one spectral sensor, such as an OES sensor. The spectral sensor may be an example of the spectral sensor 210 of FIGS. 2A and 2B, or a spectral reflectometer device. Such spectral sensor may be disposed external to a process chamber of the semiconductor device manufacturing equipment, with access to the interior of the equipment via, e.g., a viewport or other window.

At block 406, the method 400 may include determining whether a desired process condition has been achieved. Examples of the process condition include presence of gases, gases currently flowing into the process volume, time to introduce or purge gases from chamber volume, plasma active (on) or inactive (off) status, gas temperature, and plasma parameters.

In some embodiments, the determination of whether the desired process condition has been achieved may include obtaining one or more spectra based on light or electromagnetic radiation emissions from the semiconductor device manufacturing equipment, and evaluating the spectra. In some implementations, such evaluation may include comparing spectral patterns (e.g., lines and intensities of spectral lines) with known spectral information such as a reference library of lines, patterns, and/or full spectra, as discussed with respect to FIG. 3.

If the desired process condition has not been achieved, at block 408, the method 400 may include adjusting the process. In some cases, the process may be adjusted by, e.g., increasing or reducing a gas flowing into a process chamber, increasing or decreasing a flow rate of a gas, activating or deactivating a plasma (e.g., by increasing, decreasing, or stopping plasma RF power), changing plasma parameters, increasing or lowering the gas temperature and/or gas pressure within the process chamber, or changing a configuration of the fabrication tool (including, e.g., repairing components such as leaky gas valves or gas lines). Other adjustments may be envisioned by one having ordinary skill in the relevant art to achieve the desired process condition.

If the desired process condition has been achieved, at block 410, the method 400 may include determining whether to end the process. If yes, the process ends at block 412. If not, the method 400 may return to block 404 to continue collecting further spectral data.

At block 452, the method 450 may include detecting, using at least one spectral sensor, spectral characteristics of emissions from within an internal portion of the semiconductor device manufacturing equipment. In some embodiments, spectral characteristics may include patterns of spectral lines and intensities, as discussed with respect to FIG. 3.

At block 454, the method 450 may include, responsive to a determination that a desired process condition within the internal portion has not been met based on the detected spectral characteristics, adjusting a process associated with the semiconductor device manufacturing equipment toward the desired process condition.

In some embodiments, the method 450 may include, responsive to a determination that the desired process condition within the internal portion has been met based on the detected spectral characteristics, determining whether to end the process associated with the semiconductor manufacturing equipment.

The method 450 may further include, responsive to a determination not to end the process, detecting additional spectral characteristics of emissions within the internal portion using the at least one spectral sensor, or end the process responsive to a determination to end the process.

### Chamber Clean Endpoint Detection

In another example aspect and application of spectral sensing according to embodiments described herein, spectral sensing (e.g., OES) can be used to determine chamber clean endpoint. Accurate detection of chamber clean endpoint is of interest when operating process chambers. Processes performed within a process chamber, such as deposition of a conformal material film onto a substrate using, e.g., chemical vapor deposition (CVD) processes, may result in film deposition not just on the substrate, but also on various chamber surfaces as a byproduct of the processes. Over time, unwanted deposition build-up on chamber surfaces leads to particulates and potential contamination, which can negatively impact wafer yield. Hence, chamber cleans are essential to the repeatable operation of deposition tools.

Process chambers are cleaned periodically to remove such build-up of byproduct particulates. Removal of chamber deposition can be done by, e.g., reacting films of trace byproducts with reactive gas (e.g., radical fluorine, oxygen) to generate silicon tetrafluoride (SiF) which can then be removed from the chamber. The optimum clean time for a given chamber varies depending on many factors including the type of deposited material, temperature, pressure, reactive gas delivery, process gap spacing (e.g., between a substrate and a showerhead), etc. It would be advantageous to determine the endpoint of chamber clean to prevent overcleaning by, e.g., reactions with the surfaces themselves. Chamber cleans also ensure that the chamber is in a known state before the deposition process begins, and that the system is returned to a known state after a deposition process.

Chamber clean may be performed (e.g., periodically after precursor chemicals introduced into a process chamber are deposited onto a substrate and/or internal surfaces) to maintain the lifetime of the pedestal and/or improve performance of deposition or other processes. However, invariably, as noted above, there is gradual and incremental buildup of trace amounts of chemical byproducts on components of the process chamber, e.g., walls, pedestals, or showerhead.

The duration and type of cleaning required can vary depending on the history of operation. However, current approaches to chamber clean involve timed cleans (which does not account for system or process variability and/or changing accumulation based on differing processes) or usage of an infrared endpoint detector (IR-EPD). Where chamber cleans are run for a fixed time, they must always run too long to ensure consistency at the cost of accelerated tool degradation and downtime, e.g., from overclean or overetch. It is desirable to detect the clean endpoint to stop the etching process such that buildup is fully removed but not beyond that (not etching the wall or pedestal itself from the overetch). Alternatively to timed cleans, one may use a single-purpose sensor such as IR-EPD to measure the concentration of clean byproducts to detect the clean endpoint. IR-EPD looks for a certain voltage and slope of the signal and adds an overetch step. IR-EPD may result in significant etching in some regions of a chamber, reducing the lifetime of the pedestal, e.g., caused by AlF₃ formation. IR-EPD also adds a significant cost to the tool for a single application and can only monitor the “whole-chamber” condition as opposed to individual portions of a chamber (e.g., wall). This is because IR-EPD measures the effluent from the entire reactor, so there is minimal ability to correlate that measurement to a specific region. However, OES may be used in some cases to obtain more localized information using, e.g., a limited field of view.

In some embodiments of the present disclosure, a spectral sensor (e.g., OES sensor) may act as a primary sensor to indicate clean state. Spectral sensing can infer the state of the chamber, e.g., at the walls. Generally, spectral sensing can provide endpoint for multiple clean approaches including remote, direct, and hybrid. Direct cleans refer to when the remote plasma source is attached directly to the chamber instead of routing its outlet through a gas distribution system. Even though a remote plasma source is being used, the transport distance from the source to the process volume is sufficiently short that the plasma does not cool or recombine before being delivered to the chamber. As a result, there is an ample amount of light for observation. In remote cleans, the plasma is generated by a remote source and the resulting reactive species are transported to the volume of a process chamber where they diffuse to the walls and react with the coating. In hybrid cleans, the remote plasma source is used in conjunction with the generation of a plasma in the process chamber volume. Although the light generated via remote cleans is less than in direct cleans, the endpoint can be determined based on measuring the weak light, or by using a reference plasma. More specifically, spectral sensing to provide endpoints using any of these clean approaches may be accomplished by one of two approaches.

The first approach is from direct observation of the recombination glow that occurs on surfaces during the clean process. The process of surface recombination results in a dim, but observable glow near the surface in question as molecules formed in an excited state then spontaneously decay. The rate and spectral properties of this recombination glow are strongly dependent on the surface condition and thus change as the surfaces in a deposition tool are cleaned. As clean progresses, spectral signals in the light collection region may be diminished, indicating the clean state. Thus, spectral sensing (in some cases, used in conjunction with a spatial sensor, e.g., a camera) can provide indication that the clean is complete without significant overetch.

Certain spectral bands correlate to a clean condition. As such, in some implementations, spectral information can be compared to known reference library, e.g., using the approach described with respect to FIG. 3.

The second approach is direct observation of clean byproducts in the chamber volume after they have been excited by a reference plasma. In certain contexts of the present disclosure, reference plasma may refer to a plasma not associated with the fabrication process. Either during the clean process or at set intervals between clean steps, a reference plasma is struck to excite the gas in the volume. The degree of cleaning is assessed either directly through measurement of clean byproducts (e.g., SiF, AlF) or indirectly through changes in spectral features that do not participate in the clean process (e.g. nitrogen, argon). The changes in the indirect spectral features occur because of changing wall conditions (e.g., conductivity, secondary electron emission) which influence the properties of the reference plasma.

Advantageously, spectral sensing need not rely on specifically measuring clean byproducts, although in some embodiments, this may be done according to the second approaches described above. Moreover, more detail is available with spectral sensing than IR-EPD, and spectral sensing can detect endpoint on individual surfaces of the chamber (e.g., a wall, top of pedestal, bottom of pedestal, showerhead). Spectral sensing may also allow optimization of clean for different process histories. Different process histories may be associated with different amounts of film accumulation on the chamber walls. If the level of accumulation is different, then the cleaning time changes accordingly. The length of the clean may not be strictly linear with the accumulation thickness, however. Hence, rather than time of clean, a “clean rate” may be determined and set through optimization, e.g., based on machine learning models. For example, in some scenarios, the spectral sensor may determine, e.g., based on different machine learning models, which parameter(s) (pressure, gap, flow rate, temperature, etc.) to increase or decrease to accomplish the clean rate. Neural networks such as recurrent neural networks (RNNs) may also be used to change the clean rate based on control constraints.

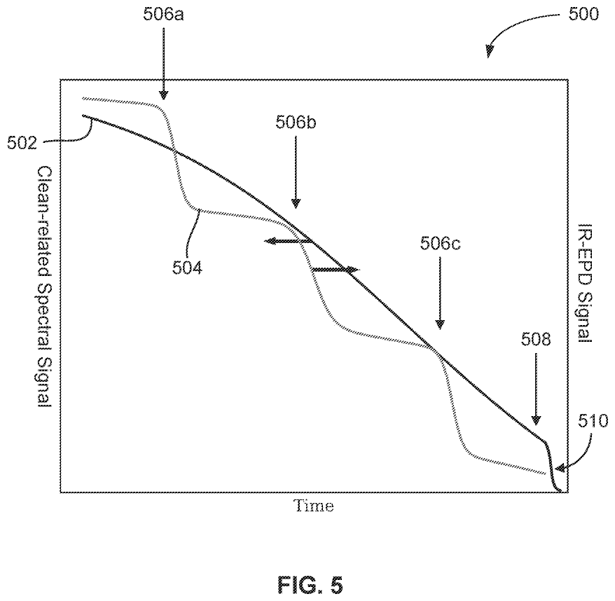

Referring to FIG. 5, a graph 500 comparing signals obtained via spectral sensing (e.g., using an OES sensor) and infrared-based signals (e.g., obtained via IR-EPD) is shown. A line 502 represents the infrared-based signals, and a line 504 represents signals obtained via spectral sensing. Note that the line 504 that represents spectral signals is marked by several “punch-through events” 506a-506c, which are sudden changes in the measured light or spectral signals (e.g., measured by intensity). These punch-through events 506a-506c may represent cleans that have been completed or that have breached a threshold (e.g., recombination glow goes below a threshold, or clean byproducts exceed a threshold).

Consider a scenario in which etching is being performed as part of chamber clean. Different parts of the chamber may be cleaned individually and separately during the cleaning process, rather than the entire chamber. For instance, etching may occur first at a pedestal, then the showerhead, then a wall (or in myriad other sequences). A breakthrough may occur for each step, wherein sudden changes in chamber condition may lead to significant changes in the spectral signal. For example, after cleaning the spindle, spectral signal may decrease, represented by a punch-through event 506a. After this, spectral signal may decrease again after cleaning the showerhead, at another punch-through event 506b. After this, spectral signal may decrease again at another punch-through event 506c after cleaning a top surface of the pedestal or a bottom surface of the pedestal. A breakthrough even may occur after other events, such as cleaning a chamber wall. Discrete cleaning events can thus be measured. Spectral sensing can thereby detect endpoint or endpoints on individual surfaces of the chamber.

In contrast, the IR-EPD signals (line 502) may be able to indicate overall clean endpoint (e.g., at time 508) and an added overetch step (e.g., at time 510), which presents a higher risk of overcleaning compared to detecting discrete endpoints using spectral sensing (e.g., punch-through event 506a-506c).

By observing this spectral data including punch-through events, overetching and damage to the tool can be prevented more effectively. Moreover, based on the spectral data, the cleaning process can be adjusted (e.g., after one of the punch-through events) to reduce damage from overcleaning, e.g., according to the methodologies described with respect to FIG. 4A or 4B.

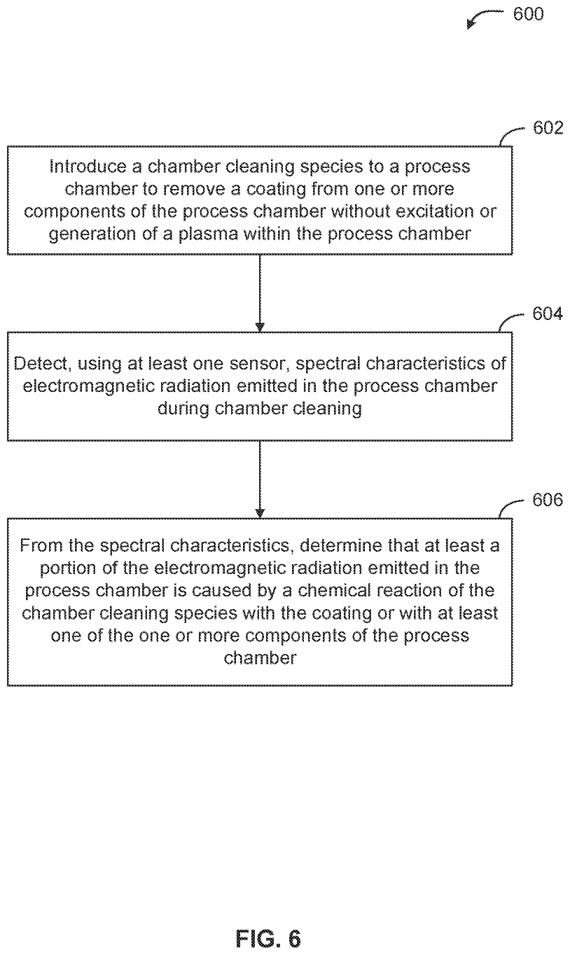

FIG. 6 is a flow diagram illustrating a method 600 for detecting clean endpoint, according to some embodiments. One or more of the functions of the method 600 may be performed by or caused by a computerized apparatus or system. Structure for performing the functionality illustrated in one or more of the steps shown in FIG. 6 may include hardware and/or software components of such computerized apparatus or system, such as, for example, a controller apparatus, a computerized system, or a computer-readable apparatus including a storage medium storing computer-readable and/or computer-executable instructions that are configured to, when executed by a processor apparatus, cause the at least one processor apparatus or a computerized apparatus to perform the operations. A controller may be one example of the computerized apparatus or system. A subsystem (e.g., 191) may be another example of the computerized apparatus or system. A process chamber may be another example of the computerized apparatus or system. Example components of a process chamber and a controller are illustrated in FIGS. 1A and 1B, and 13, respectively, and described in more detail elsewhere herein.

It should also be noted that the operations of the method 600 may be performed in any suitable order, not necessarily the order depicted in FIG. 6. Further, the method 600 may include additional or fewer operations than those depicted in FIG. 6 to detect the clean endpoint.

In some embodiments, the computerized apparatus or system may include at least one spectral sensor of a semiconductor device manufacturing apparatus.

At block 602, the method 600 may include introducing a chamber cleaning species to a process chamber to remove a coating from one or more components of the process chamber without excitation or generation of a plasma within the process chamber. Generally, excitation results from application of electrical energy to a process gas in a process chamber or other manufacturing equipment. The electrical energy may be applied inductively or capacitively, for example. Excitation may cause at least a fraction of the gas to enter an electrically excited state. In some embodiments, the chamber cleaning species introduced to the process chamber may include reactive gas (e.g., radical fluorine) to generate silicon tetrafluoride (SiF₄) which can then be removed from the chamber. In some cases, the coating may be byproduct material from deposition processes including gas species (e.g., nitride, oxide, carbon) in the form of, e.g., film that has been deposited onto various surfaces of the process chamber.

At block 604, the method 600 may include detecting, using at least one sensor, spectral characteristics of electromagnetic radiation emitted in the process chamber during chamber cleaning. In some embodiments, the sensor may be a spectral sensor of the type and with functionality and uses described with respect to FIGS. 2A-2B, including being able to capture spectral information and enable generation of spectral data such as those shown with respect to FIGS. 3 and 5. In some embodiments, spectral characteristics may include spectra or spectral patterns, which may include bands, each of which may have one or more aspects (e.g., intensity, brightness, thickness) that correlate to chamber conditions such as presence of film on a surface within the process chamber.

Electromagnetic radiation in the context of the present disclosure may refer to ultraviolet (UV), infrared (IR), and/or visible light. In some scenarios, the electromagnetic radiation may be produced by a reaction or process in the process chamber, e.g., chemiluminescence from a recombination chemical reaction. Such processes may correspond to certain spectral patterns and may be compared, e.g., to a reference library of lines or reference spectral patterns or bands, as described above.

At block 606, the method 600 may include determining, from the spectral characteristics, that at least a portion of the electromagnetic radiation emitted in the process chamber is caused by a chemical reaction of the chamber cleaning species with the coating or with at least one of the one or more components of the process chamber. Since a chemical reaction with the coating is different from a chemical reaction with the components of the process chamber (e.g., chamber wall composed of aluminum), the spectral characteristics are different as well. For example, different spectra or spectral patterns may be obtained based on the electromagnetic radiation detected (e.g., at block 604). These spectra or patterns may be known, and hence, it can be determined from the spectral characteristics that the electromagnetic radiation was caused by a chemical reaction with the coating or with a component of the process chamber.

In some embodiments, the spectral characteristics may include an intensity of bands associated with the spectral patterns. For example, a wider or brighter band in a spectral pattern indicative of the coating may indicate presence of the coating, and a thinner or fainter band may be indicative of less coating. Similarly, the bands can indicate how much of a chamber component (e.g., aluminum surfaces) is exposed.

Hence, the method 600 may further include, based on an aspect (e.g., intensity, brightness, width) of the spectral characteristics, determining whether the chamber cleaning of the one or more components has completed. In some implementations, the method 600 may further include adjusting and/or stopping one or more processes related to the process chamber based on this determination (e.g., to reduce damage from overcleaning).

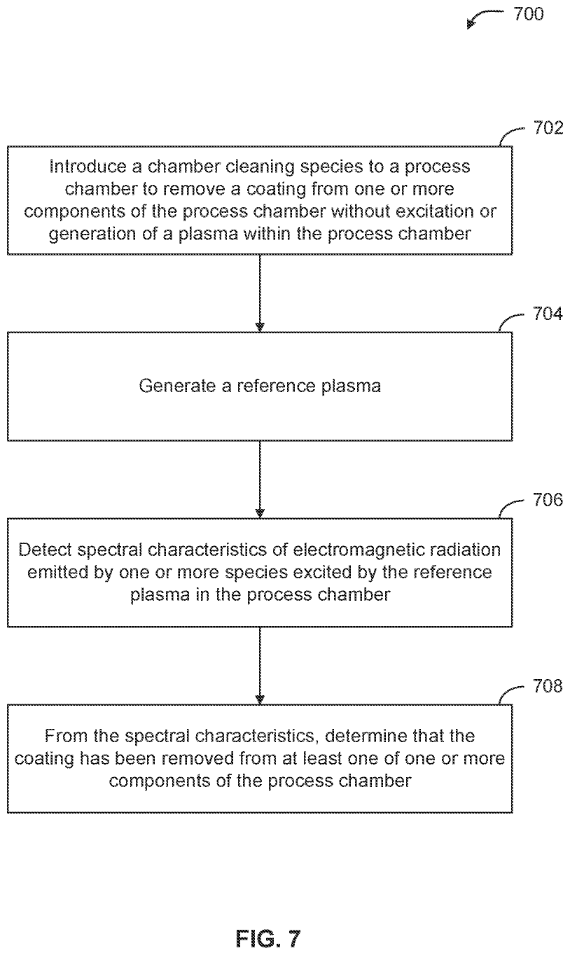

FIG. 7 is a flow diagram illustrating another method 700 for detecting clean endpoint, according to some embodiments. One or more of the functions of the method 700 may be performed by or caused by a computerized apparatus or system. Structure for performing the functionality illustrated in one or more of the steps shown in FIG. 7 may include hardware and/or software components of such computerized apparatus or system, such as, for example, a controller apparatus, a computerized system, or a computer-readable apparatus including a storage medium storing computer-readable and/or computer-executable instructions that are configured to, when executed by a processor apparatus, cause the at least one processor apparatus or a computerized apparatus to perform the operations. A controller may be one example of the computerized apparatus or system. A subsystem (e.g., 191) may be another example of the computerized apparatus or system. A process chamber may be another example of the computerized apparatus or system. Example components of a process chamber and a controller are illustrated in FIGS. 1A and 1B, and 13, respectively, and described in more detail elsewhere herein.

It should also be noted that the operations of the method 700 may be performed in any suitable order, not necessarily the order depicted in FIG. 7. Further, the method 700 may include additional or fewer operations than those depicted in FIG. 7 to detect the clean endpoint.

In some embodiments, the computerized apparatus or system may include at least one spectral sensor of a semiconductor device manufacturing apparatus.

At block 702, the method 700 may include introducing a chamber cleaning species to a process chamber to remove a coating from one or more components of the process chamber without excitation or generation of a plasma within the process chamber. In some embodiments, the chamber cleaning species introduced to the process chamber may include reactive gas (e.g., radical fluorine) to generate silicon tetrafluoride (SiF₄) which can then be removed from the chamber. In some cases, the coating may be byproduct material from deposition processes including gas species (e.g., nitride, oxide, carbon) in the form of, e.g., film that has been deposited onto various surfaces of the process chamber.

At block 704, the method 700 may include generating a reference plasma. The reference plasma is not associated with any fabrication process that may occur in the process chamber. In some embodiments, the reference plasma may be a helium plasma. In other embodiments, the reference plasma may be neon-or argon-based plasma, hydrogen plasma, or other types of plasma.

At block 706, the method 700 may include detecting spectral characteristics of electromagnetic radiation emitted by one or more species excited by the reference plasma in the process chamber. In some embodiments, the detecting may be accomplished via the use of a sensor, such as a spectral sensor of the type and with functionality and uses described with respect to FIGS. 2A-2B, including being able to capture spectral information and enable generation of spectral data such as those shown with respect to FIGS. 3 and 5.

At block 708, the method 700 may include determining, from the spectral characteristics, that the coating has been removed from at least one of one or more components of the process chamber. In some embodiments, the spectral characteristics may include spectra or spectral patterns, which may include bands, each of which may have one or more aspects (e.g., intensity, brightness, width) that correlate to chamber conditions such as presence of film on a surface within the process chamber. Therefore, in some approaches, that the coating has been removed from at least one of one or more components of the process chamber may be determined by (i) comparing the spectral characteristics with a reference library of lines or spectral patterns or bands, and (ii) determining whether there is a match between the spectral characteristics and a reference library (e.g., reference spectrum). For example, it can be determined that coating has been removed from a chamber wall if the detected spectral pattern corresponds to a spectral pattern associated with some aluminum and/or some species of the coating. As another example, it can be determined that coating has not been removed from the chamber wall if the detected spectral pattern corresponds to a spectral pattern associated with some species of the coating (without aluminum). In some cases, a partial match may be sufficient (e.g., only some spectral patterns or bands correspond to reference spectral patterns or bands).

If it is determined that the coating has been removed from at least one of one or more components of the process chamber, this determination would correspond to the chamber clean endpoint. Hence, in some implementations, the method 700 may further include adjusting and/or stopping one or more processes related to the process chamber based on this determination (e.g., to reduce damage from overcleaning).

Methods 600 and 700 are thus approaches to chamber clean using spectral information, without using approaches that result in degradation of the tool such as overly conservative timed cleans or costly IR-EPD.

### Hazard Purge

In another example aspect and application of spectral sensing according to embodiments described herein, spectral sensing (e.g., OES) can be used to detect the level of contamination from hazardous materials in or around the fabrication tool.

Related to the chamber cleaning described above, such clean presents a health hazard to operators of the tool being cleaned. Chamber cleaning may result in the adsorption of hazardous substances (e.g., a fluorine-containing species or other species that are detrimental to health and/or chemically aggressive) to surfaces throughout the tool, posing a health hazard to human operators when the chamber is opened (during chamber opening events). For example, water vapor may enter the chamber, react with fluorine-containing species to produce hydrogen fluoride (HF), and escape the chamber to create a toxic hazard to operators of the tool. Because of this safety hazard, hazardous materials must be purged prior to opening the chamber.

In some cases, this hazard may be mitigated by the use of a series of HF purge cycles, venting the chamber, and pumping it down again. The number of purge cycles is fixed and may be determined based on historic measurements using chemical sensors. However, the actual number of cycles required depends on the tool history, where such tool history may relate to, e.g., types of films deposited and/or the level of film accumulation on the walls, or mechanical properties of surfaces based on age and condition (a more porous or degraded surface could retain more of a hazardous substance). Therefore, typically, the number of cycles is conservatively set at a large number to ensure that hazardous substances are not present when opening the chamber. This significantly increases tool downtime and decreases wafer throughput.

In some embodiments of the approaches described herein, spectral sensing (e.g., using a OES sensor) may be used to assess the level of contamination (e.g., fluorine or other hazardous substance) in the chamber prior to opening. Either during using a pump/purge cycle, or using an alternative HF purge process, a reference plasma may be struck within the tool. The reference plasma may then be monitored either for direct spectral signatures of HF or for indirect spectral signatures.

As with the clean endpoint process, changes in the spectral properties of the plasma can indicate the surface condition within the tool even if the emitting species is not a product of wall interactions. The chamber condition may be a function of HF and/or other fluorine-containing species absorbed to the chamber wall or other chamber surface or component. The absorbed species impacts the plasma, which is detectable in a spectral region that exhibits strong sensitivity to the chamber condition, including to fluorine-containing species absorbed on a chamber surface.

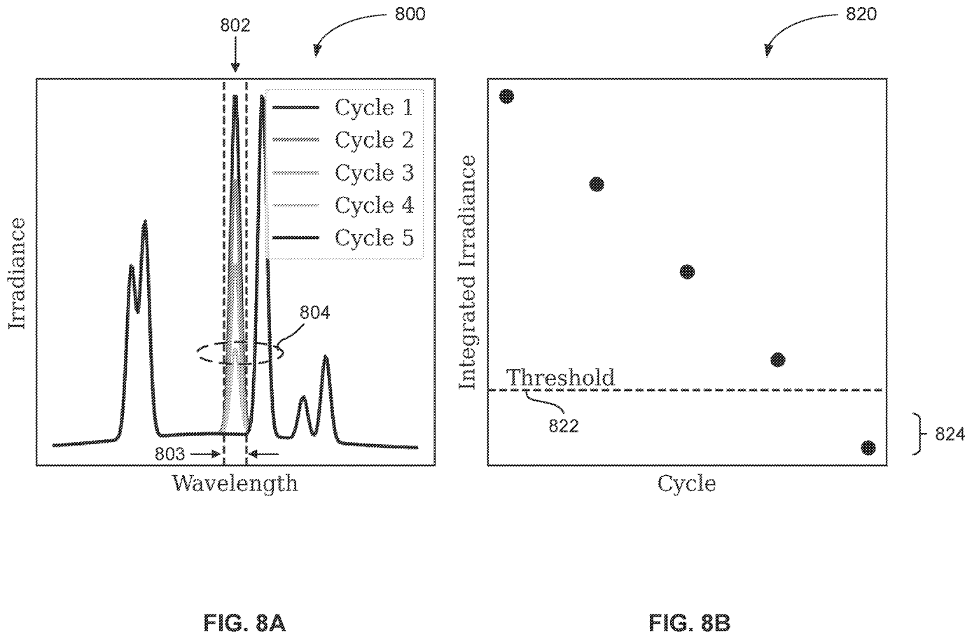

FIG. 8A is an example spectral diagram 800 indicating peaks corresponding to contamination by hazardous substance (e.g., fluorine) across a number of purge cycles. As shown, spectral peaks occur at different wavelengths of interest. For example, within certain bands (the 379-388 nm band being one example band), spectral peaks may be particularly sensitive to the chamber condition (e.g., presence of HF). It can be seen that the peaks (e.g., within the 379-388 nm band) 802 within a band 803 become lower over purge cycles. In some cases, the reductions in peaks may reduce over the purge cycles. After approximately purge cycle 5 (peak indicated by dotted oval 804), the HF-related spectral signals measured using a spectral sensor may remain relatively the same irradiance; peaks may not decrease as much. This can indicate an acceptable safety level, which in some implementations can be determined based on the HF-related spectral signals not varying by more than a threshold range or amount, or being below a threshold amount.

Notably, in some scenarios, only certain peaks or bands are highly sensitive to chamber state. In the example spectral diagram 800, the peaks 802 within the band 803 are most sensitive to the chamber state.

FIG. 8B is an example graph 820 indicating the contamination-related signals (e.g., caused by presence of HF) over the number of purge cycles. At approximately purge cycle 6 and on, the HF-related spectral signals remain relatively constant, which corresponds to the example spectral diagram 800. In some embodiments, it may be determined that the contamination is at an acceptably low enough level based on a threshold, e.g., threshold line 822. In some embodiments, it may be determined that the contamination is at an acceptably low enough level based on the signals not varying by more than a threshold amount or range 824.

Using spectral data such as those illustrated in FIGS. 6A and 6B, the number of purge cycles can be optimized. Rather than conservatively setting the number of purge cycles at a large default number, spectral data can indicate that contamination is low enough or has stabilized before the default number of purge cycles is reached. In one example, it may be determined that based on the data shown in FIGS. 8A and 8B, purge cycles can be stopped after the sixth cycle because it is below a threshold signal level (e.g., below threshold line 822). In some implementations, the threshold signal level may be determined based on an acceptably safe level of HF or even below the acceptably safe level (e.g., one or more standard deviations below). Further to the example above, the purge cycles can be stopped subsequent after the sixth cycle (e.g., on the seventh or eighth cycle) after confirming or verifying that subsequent readings stay within a maximum variation in the HF-related signal level and/or are below the threshold signal level. This additional caution can ensure that the hazard to human operators is minimized. Nonetheless, stopping purge cycles safely before the conservative number can advantageously decrease tool downtime and thereby increase wafer throughput over typical approaches because unnecessary purge cycles are eliminated.

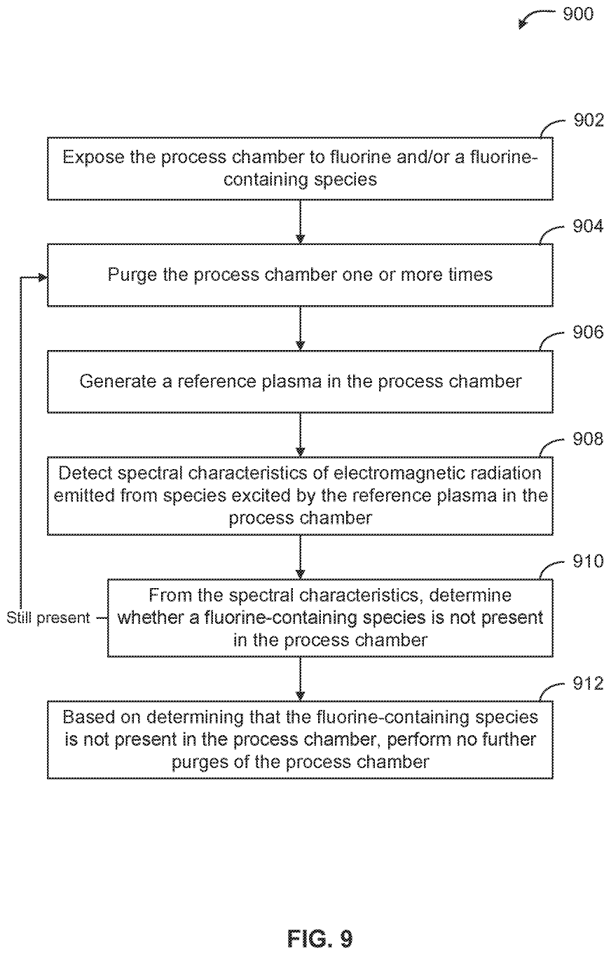

FIG. 9 is a flow diagram illustrating another method 900 to determine an optimal number of purge cycles for a semiconductor device manufacturing apparatus, according to some embodiments. One or more of the functions of the method 900 may be performed by or caused by a computerized apparatus or system. Structure for performing the functionality illustrated in one or more of the steps shown in FIG. 9 may include hardware and/or software components of such computerized apparatus or system, such as, for example, a controller apparatus, a computerized system, or a computer-readable apparatus including a storage medium storing computer-readable and/or computer-executable instructions that are configured to, when executed by a processor apparatus, cause the at least one processor apparatus or a computerized apparatus to perform the operations. A controller may be one example of the computerized apparatus or system. A subsystem (e.g., 191) may be another example of the computerized apparatus or system. A process chamber may be another example of the computerized apparatus or system. Example components of a process chamber and a controller are illustrated in FIGS. 1A and 1B, and 13, respectively, and described in more detail elsewhere herein.

It should also be noted that the operations of the method 900 may be performed in any suitable order, not necessarily the order depicted in FIG. 9. Further, the method 900 may include additional or fewer operations than those depicted in FIG. 9 to determine the optimal number of purge cycle.

In some embodiments, the computerized apparatus or system may include at least one spectral sensor of a semiconductor device manufacturing apparatus.

At block 902, the method 900 may include exposing the process chamber to a hazardous material. In some embodiments, the hazardous material may include fluorine and/or a fluorine-containing species (such as hydrogen fluoride (HF)) or other species detrimental to health and/or chemically aggressive. Such introduction to hazardous material (e.g., HF) may be a result of a process that is not necessarily, but is related to what happens before or after, deposition or other throughput-related process. For example, chamber clean may result in adsorption of hazardous substances (e.g., a fluorine-containing species) to surfaces throughout the tool, posing a health hazard to human operators during chamber opening events.

At block 904, the method 900 may include purging the process chamber one or more times. In some embodiments, the process chamber may be purged multiple times. In some implementations, the purging may comprise HF purge cycles. In some cases, the number of times the process chamber is purged may be less than a number known to result in a safe chamber condition, e.g., where the hazardous material is no longer present. For example, it may be known that 10 purges results in the process chamber having an acceptably low level of HF, so the process chamber may be purged fewer than 10 times, e.g., between 4 to 7 times, or such that this lower number of purges may or may not still result in the hazardous material remaining in the process chamber.

At block 906, the method 900 may include generating a reference plasma in the process chamber.

At block 908, the method 900 may include detecting spectral characteristics of electromagnetic radiation emitted from species excited by the reference plasma in the process chamber. In some embodiments, the spectral characteristics may be detected by a spectral sensor of the type described with respect to FIGS. 2A-2B. In some embodiments, spectral characteristics may include spectra or spectral patterns, which may include bands, each of which may have one or more aspects (e.g., intensity, brightness, width) that correlate to chamber conditions such as presence of hazardous material within the process chamber.

For example, the spectral characteristics may correlate to a presence of the fluorine-containing species within the process chamber, or may correlate to a state of the process chamber associated with the fluorine-containing species.

At block 910, the method 900 may include determining from the spectral characteristics that a fluorine-containing species is not present in the process chamber. In some approaches, determining that the fluorine-containing species is not present in the process chamber may be done by (i) comparing the spectral characteristics with a reference library of lines or spectral bands, and (ii) determining whether there is a match between the spectral characteristics and a reference spectrum. For example, if the comparison reveals no match between the spectral characteristics and a reference spectrum for the fluorine-containing species, it can be determined that the fluorine-containing species is not present. On the other hand, it can be determined that the fluorine-containing species is still present in the process chamber if the comparison does reveal a match.

At block 912, the method 900 may include, based on determining that the fluorine-containing species is not present in the process chamber, performing no further purges of the process chamber. This may correspond to, for example, purge number 6 and on in FIG. 8B. In some implementations, performing no further purges may be further based on an indication of an acceptable safety level determined based on the HF-related spectral signals not varying by more than a threshold range or amount (e.g., 824 of FIG. 8B), or being below a threshold amount (e.g., 822 of FIG. 8B).

In some embodiments, determining that the fluorine-containing species is not present in the process chamber may include performing a further purge, a “safety purge.” Although this may result in a more conservative number of purge cycles, this additional caution can ensure that the hazard to human operators is minimized.

In some embodiments, the method 900 may include performing one or more further purges of the process chamber based on determining that the fluorine-containing species is still present in the process chamber. This may correspond to, for example, purge number 3 or 4 in FIG. 8B. In some embodiments, performing further purges of the process chamber may result in the method 900 returning to block 904 to purge the process chamber one or more times, generate the reference plasma, and determining whether the fluorine-containing species is present. In some embodiments, when purging of the process chamber one or more times during these subsequence purge cycles, the number of purge cycles may be reduced as compared to the initial number of purge cycles, e.g., to one purge cycle.

Since a goal of using spectral signals is to determine an optimal number of purge cycles, reducing subsequent cycles can prevent the cycles from happening more than necessary. However, this number may also be balanced with the RF power required to generate the reference plasma (block 806), as it may not be known how many more times the purge cycle must occur to reach an acceptable safety level of the hazardous material. Hence, in some implementations, the reduction of the number of purge cycles may be tapered down rather than reduced to the minimum number of one.

### Trace Gas and Leak Detection

In another example aspect and application of spectral sensing according to embodiments described herein, spectral sensing (e.g., OES) can be used to detect trace gases in fabrication tools. A concern regarding trace gas is the presence of air leaks, valve leaks, or other indications of a burst of gas more than what was expected occurs during a process step. Some deposition processes very sensitive to trace contaminants.

Conventional approaches do not provide an instantaneous response. Typically, air leaks can be identified either through rate-of-rise measurements for gross leaks, or with the help of a leak detector (e.g., a helium leak detector, a type of mass spectrometer) for small leaks. However, rate-of-rise measurements take a long time to conduct, especially for small leaks, and lack precision. Meanwhile, leak detectors are cumbersome, require breaking vacuum (e.g., of a process chamber or at a foreline), and are often limited in availability. Trace gases that are not air, such as impurities in process gases or outgassing of surfaces, are generally identified with the use of a mass spectrometer. Mass spectrometers have similar drawbacks of a leak detector and are typically not suitable for use in reactive chemistries such as those found in deposition equipment. More specifically, mass spectrometers can be limited to specific species, expensive, intrusive (e.g., requiring integration in vacuum system), or susceptible to contamination created by a chemically harsh environment.

Instead, spectral sensing and measurement may be used in accordance with spectral sensors (e.g., an OES sensor) and embodiments disclosed herein (without having to use a mass spectrometer or perform length rate-of-rise measurements). Spectral sensors can be configured to sense many different species, have a lower cost, and not intrude on the process volume, unlike the commonly used equipment above. In some embodiments, spectral features that are related to the contaminant in question may be measured. For example, measuring the integrated intensity of a spectral band for a species (e.g., a nitrogen band) can be used as a means to assess the presence of an air leak. This can be done by striking a plasma in a continual flow of gas, then closing both the pump valve and shutting off the gas flow. By tracking the integrated intensity of the nitrogen band over time, one can infer a leak rate by normalization to a reference line (e.g., an argon transition) and an initial calibration measurement (e.g., rate of rise).

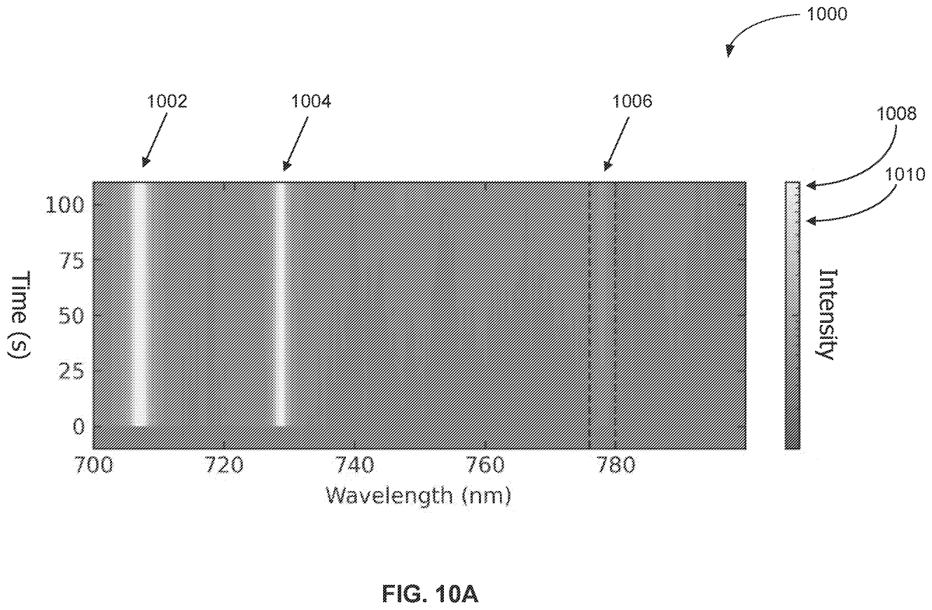

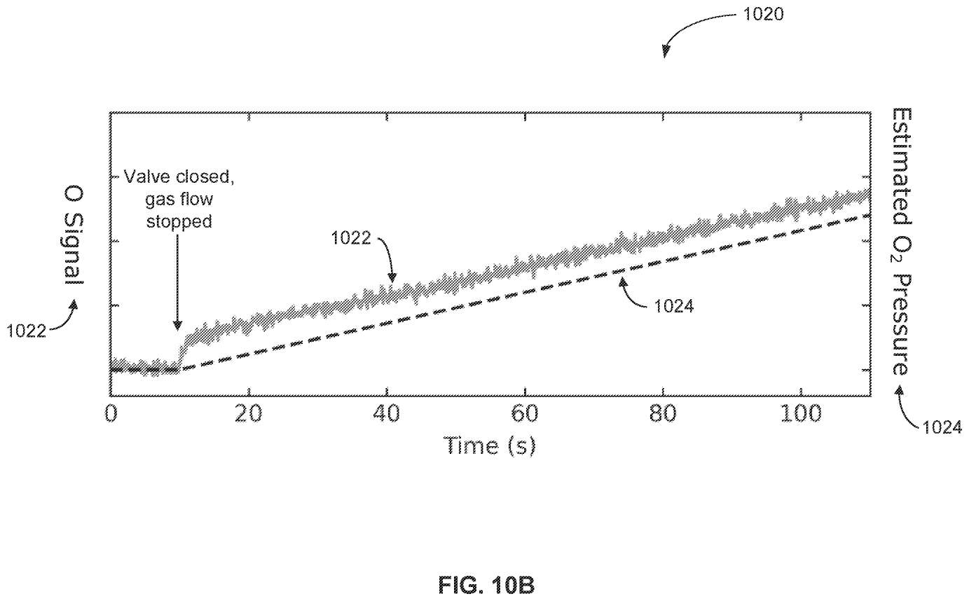

FIG. 10A is an example spectral graph 1000 indicative of the presence of different gas species. In some approaches, plasma (containing, e.g., helium) may be struck at time=0 in a process chamber that has closed off the vacuum pump and all of the valves to the gas source to create a stagnant volume. The plasma strike may result in electromagnetic radiation (e.g., light) from any gas species that is dissociated and then excited in the plasma. Based on spectral data collected (e.g., using a spectral sensor) subsequent to the plasma strike over time (here, over 100 seconds), the example spectral graph 1000 may be generated. Certain spectral lines or bands may be indicated in the example spectral graph 1000, where intensity is the highest at around level 1008 and lesser around level 1010. Spectral lines 1002 and 1004 on the example spectral graph 1000 may have an intensity that is about level 1008 and correspond to helium. Spectral line 1006 may have an intensity that is about level 1010 and correspond to atomic oxygen. Since valves have been closed and gas flow has stopped at time=0, any detected presence of gas may indicate a leak thereof. In this case, any oxygen that is detected (based on the spectral line 1006, albeit faint) can be inferred to be leaking in, e.g., from the walls or through leaks in the gas valves or lines or seals.

In this case, since the quantity of oxygen in the system is low, it does not appreciably change the plasma. The plasma more or less remains the same. However, by measuring this change in signal (e.g., oxygen signal) intensities over time (e.g., 100 seconds or more), a graph 1020 as shown in FIG. 10B can be obtained. A plot 1022 indicates a relatively consistent increase in the intensity of light from the oxygen signal.

In alternate approaches, rather than striking a plasma, rise of oxygen may be measured with a pressure sensor (e.g., manometer) and obtain a similar indication of rising oxygen with line 1024 measuring gas pressure. However, this type of measurement would require a long period of time (e.g., hours) because the leak in this case is small. In contrast, with spectral measurements according to the above approach, similar measurements and indications may be obtained in a much shorter period of time (e.g., minutes or as short as seconds). That is, indications of very sensitive (e.g., small leak) measurements of air or gas leaks in the fabrication system or components thereof may be obtained with a spectral sensor, without resorting to larger, more expensive equipment that may be of limited availability.

### Limited Magnitude Signal Detection

In some processes, the spectral signal emitted by a species under consideration in the process chamber may be weak (e.g., below a reliable detection limit or other predetermined limit of a spectral sensor). Examples of reasons for a weak spectral (e.g., OES) signal include (i) no plasma is present in the chamber when the spectral signal is needed (e.g., HF purge) and (ii) the local plasma power is insufficient to sufficiently excite the species under consideration. One example of systems that produce a locally weak plasma are systems that employ a remote plasma such as is used in some chamber cleaning operations. Such limited-magnitude spectral signal may be addressed by one or more of the following techniques.

In some cases, some spectral signals may be obtained from chemiluminescence or other light emitted by a chemical reaction, e.g., light emitted by fluorine or a fluorine-containing species reacting with a material on a chamber wall. This may occur during reaction of fluorinated species in chamber cleaning.

In some cases, a reference plasma may be generated which is a plasma that is not required for the process under consideration (e.g., it is not required for an etch, deposition, or clean process) or is a plasma that is generated primarily or exclusively for the purpose of facilitating spectral or OES detection. The reference plasma can excite a species of interest, and the emitted spectra of the emitted species can be detected by a spectral sensor. For example, HF might be detected by spectral signals from HF excited by the reference plasma.

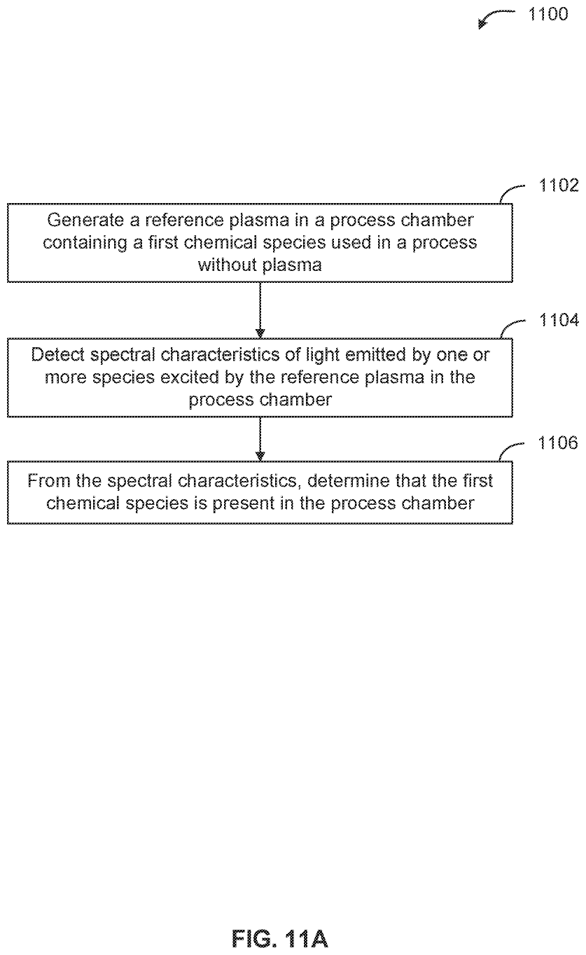

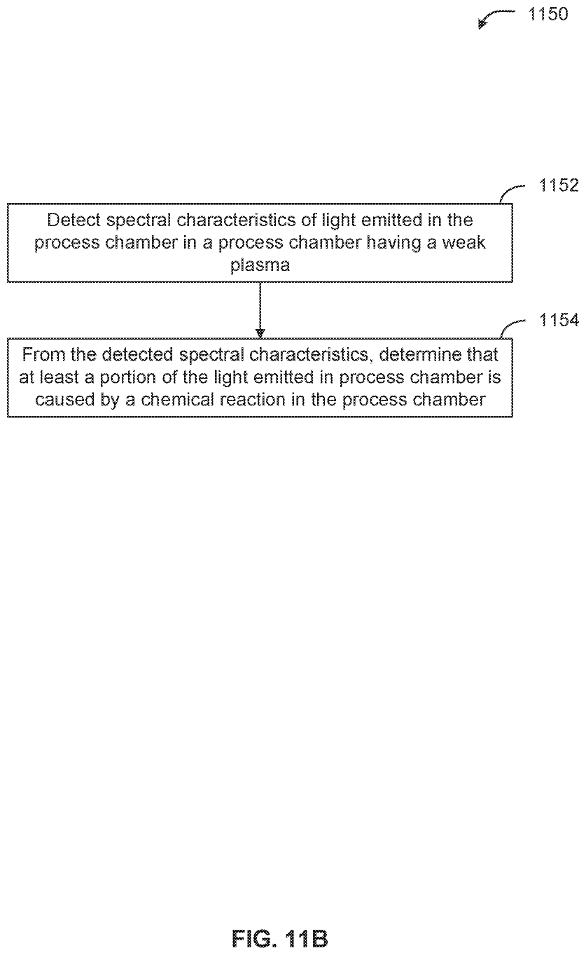

FIGS. 11A and 11B are flow diagrams illustrating methods 1100 and 1150 of detecting limited-magnitude spectral signals within a process chamber of semiconductor device manufacturing equipment, according to some embodiments. One or more of the functions of the methods 1100 and 1150 may be performed by or caused by a computerized apparatus or system. Structure for performing the functionality illustrated in one or more of the steps shown in FIGS. 11A and 11B may include hardware and/or software components of such computerized apparatus or system, such as, for example, a controller apparatus, a computerized system, or a computer-readable apparatus including a storage medium storing computer-readable and/or computer-executable instructions that are configured to, when executed by a processor apparatus, cause the at least one processor apparatus or a computerized apparatus to perform the operations. A controller may be one example of the computerized apparatus or system. A subsystem (e.g., 191) may be another example of the computerized apparatus or system. A process chamber may be another example of the computerized apparatus or system. Example components of a process chamber and a controller are illustrated in FIGS. 1A and 1B, and 13, respectively, and described in more detail elsewhere herein.

It should also be noted that the operations of the methods 1100 and 1150 may be performed in any suitable order, not necessarily the order depicted in FIGS. 11A and 11B. Further, the methods 1100 and 1150 may include additional or fewer operations than those depicted in FIGS. 11A and 11B to detect limited spectral signals.

In some embodiments, the computerized apparatus or system may include at least one spectral sensor of a semiconductor device manufacturing apparatus.

Referring to FIG. 11A, at block 1102, the method 1100 may include generating a reference plasma in a process chamber containing a first chemical species used in a process without plasma. The reference plasma is not a plasma associated with a fabrication process. In some embodiments, the reference plasma may be a helium plasma. In other embodiments, the reference plasma may be neon- or argon-based plasma, hydrogen plasma, or other types of plasma. In some scenarios, the first chemical species may be a gas such as oxygen. In some cases, the gas may be present in the process chamber in a trace amount because of a leak, even when the vacuum pump and all of the valves to the gas source are closed.

At block 1104, the method 1100 may include detecting spectral characteristics of light emitted by one or more species excited by the reference plasma in the process chamber. In some embodiments, the detecting may be accomplished via the use of a sensor, such as a spectral sensor of the type and with functionality and uses described with respect to FIGS. 2A-2B, including being able to capture spectral information and enable generation of spectral data such as those shown with respect to FIGS. 3, 10A and 10B. In some embodiments, spectral characteristics may include spectra or spectral patterns, which may include bands, each of which may have one or more aspects (e.g., intensity, brightness of a line relative to a reference line, width in some cases) that correlate to chamber conditions such as gas leaks resulting in trace amounts of the gas in the process chamber.

At block 1106, the method 1100 may include determining from the spectral characteristics that the first chemical species is present in the process chamber. In some embodiments, determining that the first chemical species is present may be done by (i) comparing the spectral characteristics with a reference library of lines or spectral bands, and (ii) determining whether there is a match between the spectral characteristics and a reference spectrum. For example, if the comparison reveals no match between the spectral characteristics and a reference spectrum for the first chemical species, it can be determined that the first chemical species is not present. On the other hand, it can be determined that the first chemical species is present in the process chamber if the comparison does reveal a match. In some cases, intensity values of the spectral characteristics may be taken into account. If an intensity value from the detected spectral characteristics does not reach a threshold level (e.g., if the oxygen signal does not reach level 1010 of FIG. 10A or some other predetermined value), it may not be considered a match with a reference spectrum. As shown in FIGS. 10A and 10B, even trace amounts of the first chemical species may be detected, especially over some time (e.g., 100 seconds or more).

In some embodiments, method 400 or 450 described with respect to FIGS. 4A and 4B may be used to detect trace gas leaks and adjust the process. For example, based on detecting a gas leak using spectral data obtained via a spectral sensor, a configuration of the fabrication tool may be changed (including, e.g., repairing components such as leaky gas valves or gas lines).

Referring to FIG. 11B, a flow diagram illustrating a more generalized method 1150 for detecting limited-magnitude spectral signals within a process chamber is shown. At block 1152, the method 1150 may include detecting spectral characteristics of light emitted in the process chamber in a process chamber having a weakly ionized gas. In some embodiments, a spectral sensor (e.g., OES sensor) may detect and identify components of the emitted light at specific wavelengths and intensities (such as the example spectra shown in FIG. 3). Spectral lines or bands and their intensities and/or widths may be examples of the spectral characteristics of light.

At block 1154, the method 1150 may include, from the detected spectral characteristics, determining that at least a portion of the light emitted in process chamber is caused by a chemical reaction in the process chamber. In some cases, the light may be produced via chemiluminescence from the chemical reaction (e.g., recombination chemical reaction). In some cases, the light may be produced from excitation of a gas species with the plasma in the process chamber.

In some cases, intensity of the spectral lines may be faint because of low spectral signals caused by, e.g., little or weak reactions in the process chamber. It may be difficult to detect low-light chemiluminescence using a camera, for instance. To that end, in some embodiments, the determination that the at least portion of the emitted light is caused by the chemical reaction may be based on an evaluation of spectral characteristics with respect to a reference library of known lines and/or spectra for chemical reactions of interest. For example, the components of the emitted light at specific wavelengths and intensities (detected and identified using, e.g., the spectral sensor) may be compared to the components to the reference library to find a match that indicates that the emitted light corresponds to a chemical reaction that is known to produce substantially similar components. A spectral characteristic such as a spectral band may be said to be substantially similar if the associated wavelengths are close within a margin (e.g., within the spectrometer resolution, e.g., about 2 nm) and/or the brightness of a detected band and a reference band are within a margin.

In some embodiments, the method 1150 may further include performing at least one operation with respect to the process chamber based on the determination that the at least portion of the emitted light is caused by the chemical reaction. Some examples of the operation performed include process diagnostics, process control, chamber clean endpoint detection, hazard purge (e.g., determining when to stop purge cycles for HF contamination), and other applications as discussed herein.

### Indirect Detection of Chamber State

Regarding indirect detection of spectral signatures, a chamber condition or chamber state is not simply the presence or concentration of a particular chemical species that produces a particular spectrum when excited in the chamber. In other words, a chamber condition is not defined simply by the presence or absence of a chemical species. A chamber condition may be a characteristic of the chamber itself which is to be monitored.

An example is the presence of a particular coating or species (or lack thereof) on a chamber wall. Walls coated with a dielectric material (e.g., a wall needing cleaning) produce a different plasma response (and hence reflect a different plasma state) than metallic (e.g., uncoated or clean) walls. A chamber condition can impact a plasma state which impacts at least a portion of a spectral signal. Thus, a chamber condition may be determined indirectly from a spectral signal produced by a species in the chamber. Another example is an adsorbed species such as fluorine or hydrogen fluoride (e.g., leftover fluorine species from a chamber clean). Another example is a gas leak within a process chamber, including in trace amounts.

A mechanism for using spectral information to characterize chamber state or condition may involve some spectral peaks of certain chemical species being very sensitive to general plasma conditions that vary according to chamber state or condition. Some approaches to characterizing a chamber state may involve generating a reference plasma and analyzing a resulting spectral signal; the magnitude of certain peaks of certain chemical species in the chamber are strongly dependent on the state of the process chamber.

The relation of chamber state or condition to OES sequence may follow an indirect path such as the following:
Chamber state: A chamber state or chamber condition is a characteristic of the chamber to be determined. One example of a chamber state or chamber condition is the presence of a coating or species on a chamber wall or pedestal. Walls coated with a dielectric material (e.g., a wall needing cleaning) produce a different plasma response (and hence reflect a different plasma state) than metallic (e.g., uncoated or clean) walls. Another example is adsorbed species such as fluorine or hydrogen fluoride (e.g., left over F species from a chamber clean.
Chamber physical property: A chamber physical property is a physical property of the chamber caused by the chamber state. Further, a chamber physical property may directly influence a plasma state; examples of chamber physical states include the chamber wall conductivity, the chamber wall temperature, emissivity, secondary electron coefficient, and surface morphology. Note that in some applications, the chamber state and chamber physical property merge into one feature such as a chamber physical property such as the conductivity of the chamber wall.
Plasma state: A plasma state is a characteristic of plasma within the chamber that is caused by the chamber physical property, and the plasma state has a strong influence on one or more portions of an emission spectrum of one or more chemical species in the chamber. Examples of plasma states include plasma density, plasma potential, electron temperature, and degree of ionization.
Spectral signal or OES signal: One or more portions of a spectral signal are very sensitive to a plasma state, and hence indirectly indicate a chamber state. In practice, a spectral detection scheme (e.g., using OES sensor) may be designed to use a particular peak or other region of the spectra of one or more components in the process chamber. The peak or other region may be chosen because it exhibits strong sensitivity to plasma state. An example of spectral signal sensitivity is demonstrated in FIG. 8A, where only certain peaks or bands are highly sensitive to chamber state.

The aforementioned applications for a spectral sensor can be generalized as a determination of a chamber condition or chamber state in a process chamber of semiconductor device manufacturing equipment. Some approaches to characterizing a chamber condition involve generating a reference plasma and analyzing a resulting spectral signal, and the magnitude of certain peaks of certain chemical species in the chamber are strongly dependent on the condition or state of the process chamber.

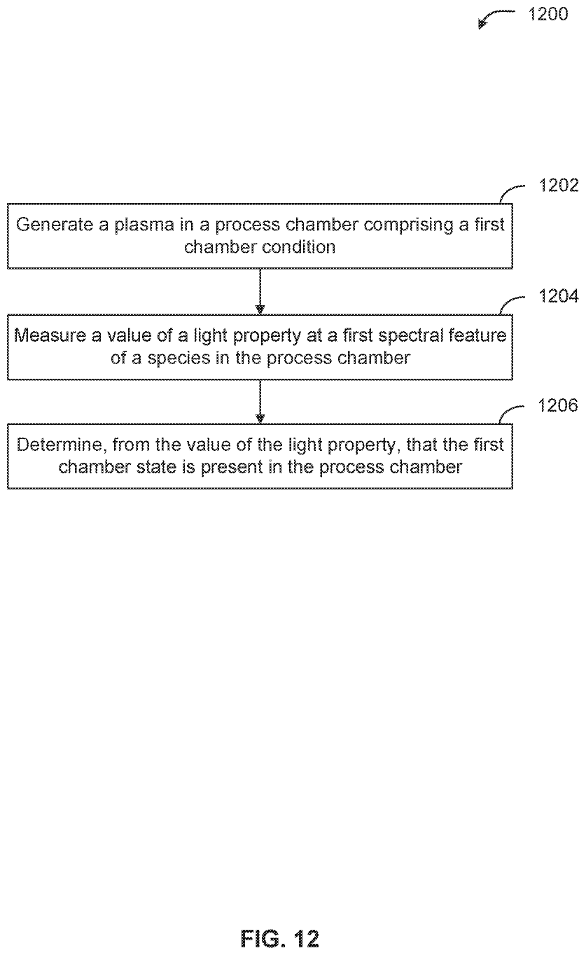

FIG. 12 is a is a flow diagram illustrating another method 1200 of indirectly determining a chamber condition of a process chamber of semiconductor device manufacturing equipment, according to some embodiments. One or more of the functions of the method 1200 may be performed by or caused by a computerized apparatus or system. Structure for performing the functionality illustrated in one or more of the steps shown in FIG. 12 may include hardware and/or software components of such computerized apparatus or system, such as, for example, a controller apparatus, a computerized system, or a computer-readable apparatus including a storage medium storing computer-readable and/or computer-executable instructions that are configured to, when executed by a processor apparatus, cause the at least one processor apparatus or a computerized apparatus to perform the operations. A controller may be one example of the computerized apparatus or system. A subsystem (e.g., 191) may be another example of the computerized apparatus or system. A process chamber may be another example of the computerized apparatus or system. Example components of a process chamber and a controller are illustrated in FIGS. 1A and 1B, and 13, respectively, and described in more detail elsewhere herein.

It should also be noted that the operations of the method 1200 may be performed in any suitable order, not necessarily the order depicted in FIG. 12. Further, the method 1200 may include additional or fewer operations than those depicted in FIG. 12 to indirectly determining the chamber condition.

In some embodiments, the computerized apparatus or system may include at least one spectral sensor of a semiconductor device manufacturing apparatus.

At block 1202, the method 1200 may include generating a plasma in a process chamber comprising a first chamber condition. In some embodiments, the first chamber condition may influence the plasma in a manner that plasma exhibits a first plasma state. Examples of the first chamber condition include the presence of a particular coating or species (or lack thereof) on a chamber wall, an adsorbed species such as fluorine or hydrogen fluoride (e.g., leftover fluorine species from a chamber clean), and a gas leak within a process chamber, including in trace amounts. In another example, the first chamber condition may be associated with a physical property of the process chamber, the first plasma state being based on the physical property, wherein the physical property of the process chamber may include a conductivity of the surface of the process chamber, a temperature of the process chamber, or a combination thereof. In some applications, the chamber condition and chamber physical property merge into one feature such as the conductivity of a chamber wall. In another example, the first plasma state may be plasma density, plasma potential, electron temperature, degree of ionization, or a combination thereof, wherein the first plasma state is based on the first chamber condition.

At block 1204, the method 1200 may include measuring a value of a light property at a first spectral feature of a species in the process chamber. In some embodiments, the light property may be intensity of a spectral line or band, intensity or strength of a spectral signal at a particular wavelength, or a spectral pattern (e.g., locations of spectral lines or bands at certain wavelengths). In some embodiments, the light property may be an intensity of light emitted based on the species in the process chamber reacting with the plasma. In some embodiments, the first spectral feature is sensitive to the first plasma state. A spectral feature may be considered sensitive when it has an intensity or other light property that responds more strongly than at least some other spectral features to a plasma state or a chamber condition. Some spectral peaks of certain chemical species are very sensitive to general plasma conditions that vary according to chamber condition.

At block 1206, the method 1200 may include determining, from the value of the light property, that the first chamber state is present in the process chamber. The light property may indicate that the species is causing or influencing the first chamber condition of the process chamber. For example, when a spectral band associated with oxygen is faint but growing in intensity over time, it may indicate a gas leak (see, e.g., FIGS. 10A and 10B). As another example, when spectral signals relating to chamber clean of film are diminishing and experiencing punch-through events (see, e.g., FIG. 5), it may indicate clean states of the different portions (e.g., wall, pedestal) of the process chamber. In some cases, determining that the first chamber condition is present in the process chamber may be based on the value of the light property meeting or exceeding a threshold. For example, the light property (e.g., intensity) needs to be above a certain level to indicate the chamber condition (e.g., of HF contamination).

In some cases, one or more portions of a spectral signal are very sensitive to a plasma state, and hence indirectly indicate a chamber condition. In practice, a spectral detection scheme can be designed to use a particular peak or other region of spectra of one or more components in the process chamber. The peak or other region can be chosen because it exhibits strong sensitivity to the chamber condition or plasma state.

### Apparatus—Computational and Controller Embodiments

FIG. 13 is a block diagram of an example of the computing device 1300 suitable for use in implementing some embodiments of the present disclosure. For example, device 1300 may be suitable for implementing some or all functions of image analysis logic disclosed herein.

Computing device 1300 may include a bus 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, and one or more presentation components 1318 (e.g., display(s)). In addition to CPU 1306 and GPU 1308, computing device 1300 may include additional logic devices that are not shown in FIG. 13, such as but not limited to an image signal processor (ISP), a digital signal processor (DSP), an ASIC, an FPGA, or the like.

Although the various blocks of FIG. 13 are shown as connected via the bus 1302 with lines, this is not intended to be limiting and is for clarity only. For example, in some embodiments, a presentation component 1318, such as a display device, may be considered an I/O component 1314 (e.g., if the display is a touch screen). As another example, CPUs 1306 and/or GPUs 1308 may include memory (e.g., the memory 1304 may be representative of a storage device in addition to the memory of the GPUs 1308, the CPUs 1306, and/or other components). In other words, the computing device of FIG. 13 is merely illustrative. Distinction is not made between such categories as “workstation,” “server,” “laptop,” “desktop,” “tablet,” “client device,” “mobile device,” “hand-held device,” “electronic control unit (ECU),” “virtual reality system,” and/or other device or system types, as all are contemplated within the scope of the computing device of FIG. 13.

Bus 1302 may represent one or more busses, such as an address bus, a data bus, a control bus, or a combination thereof. The bus 1302 may include one or more bus types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus.

Memory 1304 may include any of a variety of computer-readable media. The computer-readable media may be any available media that can be accessed by the computing device 1300. The computer-readable media may include both volatile and nonvolatile media, and removable and non-removable media. By way of example, and not limitation, the computer-readable media may comprise computer-storage media and/or communication media.

The computer-storage media may include both volatile and nonvolatile media and/or removable and non-removable media implemented in any method or technology for storage of information such as computer-readable instructions, data structures, program modules, and/or other data types. For example, memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1300. As used herein, computer storage media does not comprise signals per se.

The communication media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the communication media may include wired media such as a wired network or direct-wired connection, and wireless media such as acoustic, RF, infrared and other wireless media. Combinations of any of the above should also be included within the scope of computer-readable media.

CPU(s) 1306 may be configured to execute the computer-readable instructions to control one or more components of the computing device 1300 to perform one or more of the methods and/or processes described herein. CPU(s) 1306 may each include one or more cores (e.g., one, two, four, eight, twenty-eight, seventy-two, etc.) that are capable of handling a multitude of software threads simultaneously. CPU(s) 1306 may include any type of processor and may include different types of processors depending on the type of computing device 1300 implemented (e.g., processors with fewer cores for mobile devices and processors with more cores for servers). For example, depending on the type of computing device 1300, the processor may be an ARM processor implemented using Reduced Instruction Set Computing (RISC) or an x86 processor implemented using Complex Instruction Set Computing (CISC). Computing device 1300 may include one or more CPUs 1306 in addition to one or more microprocessors or supplementary co-processors, such as math co-processors.

GPU(s) 1308 may be used by computing device 1300 to render graphics (e.g., 3D graphics). GPU(s) 1308 may include many (e.g., tens, hundreds, or thousands) of cores that are capable of handling many software threads simultaneously. GPU(s) 1308 may generate pixel data for output images in response to rendering commands (e.g., rendering commands from CPU(s) 1306 received via a host interface). GPU(s) 1308 may include graphics memory, such as display memory, for storing pixel data. The display memory may be included as part of memory 1304. GPU(s) 1308 may include two or more GPUs operating in parallel (e.g., via a link). When combined, each GPU 1308 can generate pixel data for different portions of an output image or for different output images (e.g., a first GPU for a first image and a second GPU for a second image). Each GPU can include its own memory or can share memory with other GPUs.

In examples where the computing device 1300 does not include the GPU(s) 1308, the CPU(s) 1306 may be used to render graphics.

Communication interface 1310 may include one or more receivers, transmitters, and/or transceivers that enable computing device 1300 to communicate with other computing devices via an electronic communication network, included wired and/or wireless communications. Communication interface 1310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet), low-power wide-area networks (e.g., LoRaWAN, SigFox, etc.), and/or the internet.

I/O ports 1312 may enable the computing device 1300 to be logically coupled to other devices including I/O components 1314, presentation component(s) 1318, and/or other components, some of which may be built in to (e.g., integrated in) computing device 1300. Illustrative I/O components 1314 include a microphone, mouse, keyboard, joystick, track pad, satellite dish, scanner, printer, wireless device, etc. I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of computing device 1300. Computing device 1300 may be include depth cameras, such as stereoscopic camera systems, infrared camera systems, RGB camera systems, touchscreen technology, and combinations of these, for gesture detection and recognition. Additionally, computing device 1300 may include accelerometers or gyroscopes (e.g., as part of an inertia measurement unit (IMU)) that enable detection of motion. In some examples, the output of the accelerometers or gyroscopes may be used by computing device 1300 to render immersive augmented reality or virtual reality.

Power supply 1316 may include a hard-wired power supply, a battery power supply, or a combination thereof. Power supply 1316 may provide power to computing device 1300 to enable the components of computing device 1300 to operate.

Presentation component(s) 1318 may include a display (e.g., a monitor, a touch screen, a television screen, a heads-up-display (HUD), other display types, or a combination thereof), speakers, and/or other presentation components. Presentation component(s) 1318 may receive data from other components (e.g., GPU(s) 1308, CPU(s) 1306, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

In some implementations, a “controller” (e.g., 190) is part of a system containing a various types of sensors as described herein. Such systems include a fabrication tool with a camera sensor. Such systems can include semiconductor processing equipment, including a processing tool or tools, chamber or chambers, a platform or platforms for processing, and/or specific processing components (a wafer pedestal, a gas flow system, etc.). These systems may be integrated with electronics for controlling their operation before, during, and after processing of a semiconductor wafer or substrate. The controller may be implemented with or coupled to analysis logic as described above. A controller may be implemented as logic such as electronics having one or more integrated circuits, memory devices, and/or software that receive instructions, issue instructions, control operation, and/or enable sensing operations.

The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings in some systems, RF matching circuit settings, frequency settings, flow rate settings, fluid delivery settings, positional and operation settings, wafer transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process on or for a semiconductor wafer or to a system. The operational parameters may, in some embodiments, be part of a recipe defined by process engineers to accomplish one or more processing steps during the processing of one or more layers, materials, metals, oxides, silicon, silicon dioxide, surfaces, circuits, and/or dies of a wafer.

A controller may be configured to control or cause control of various components or subparts of the system or systems. The controller, depending on the processing requirements and/or the type of system, may be programmed to control any of the processes that may be used by a fabrication tool during a fabrication operation, including adjusting or maintaining the delivery of processing gases, temperature settings (e.g., heating and/or cooling) including substrate temperature and chamber wall temperature, pressure settings including vacuum settings, plasma settings, RF matching circuit settings, and substrate positional and operation settings, including substrate transfers into and out of a fabrication tool and/or load lock. Process gas parameters include the process gas composition, flow rate, temperature, and/or pressure. Of particular relevance to the disclosed embodiments, controller parameters may relate to plasma generator power, pulse rate, and/or RF frequency.

Process parameters under the control of a controller may be provided in the form of a recipe and may be entered utilizing a user interface. Signals for monitoring the process may be provided by analog and/or digital input connections of the system controller. The signals for controlling the process are output on the analog and digital output connections of the deposition apparatus.

In one example, the instructions for bringing about ignition or maintenance of a plasma are provided in the form of a process recipe. Relevant process recipes may be sequentially arranged, so that at least some instructions for the process can be executed concurrently. In some implementations, instructions for setting one or more plasma parameters may be included in a recipe preceding a plasma ignition process. For example, a first recipe may include instructions for a first time delay, instructions for setting a flow rate of an inert gas (e.g., helium) and/or a reactant gas, and instructions for setting a plasma generator to a first power set point. A second, subsequent recipe may include instructions for a second time delay and instructions for enabling the plasma generator to supply power under a defined set of parameters. A third recipe may include instructions for a third time delay and instructions for disabling the plasma generator. It will be appreciated that these recipes may be further subdivided and/or iterated in any suitable way within the scope of the present disclosure. In some deposition processes, a duration of a plasma strike may correspond to a duration of a few seconds, such as from about 3 seconds to about 15 seconds, or may involve longer durations, such as durations of up to about 30 seconds, for example. In certain implementations described herein, much shorter plasma strikes may be applied during a processing cycle. Such plasma strike durations may be on the order of less than about 50 milliseconds, with about 25 milliseconds being utilized in a specific example. As explained, plasma may be pulsed.

In some embodiments, a controller is configured to control and/or manage the operations of a RF signal generator. In certain implementations, a controller is configured to determine upper and/or lower thresholds for RF signal power to be delivered to a fabrication tool, determining actual (such as real-time) levels of RF signal power delivered to integrated circuit fabrication chamber, RF signal power activation/deactivation times, RF signal on/off duration, duty cycle, operating frequency, and so forth.

As further examples, a controller may be configured to control the timing of various operations, mixing of gases, the pressure in a fabrication tool, the temperature in a fabrication tool, the temperature of a substrate or pedestal, the position of a pedestal, chuck and/or susceptor, and a number of cycles performed on one or more substrates.

A controller may comprise one or more programs or routines for controlling designed subsystems associated with a fabrication tool. Examples of such programs or routines include a substrate positioning program, a process gas control program, a pressure control program, a heater control program, and a plasma control program. A substrate positioning program may include program code for process tool components that are used to load the substrate onto a pedestal and to control the spacing between the substrate and other parts of a fabrication tool. A positioning program may include instructions for moving substrates in and out of the reaction chamber to deposit films on substrates and clean the chamber.

A process gas control program may include code for controlling gas composition and flow rates and for flowing gas into one or more process stations prior to deposition to bring about stabilization of the pressure in the process station. In some implementations, the process gas control program includes instructions for introducing gases during formation of a film on a substrate in the reaction chamber. This may include introducing gases for a different number of cycles for one or more substrates within a batch of substrates. A pressure control program may include code for controlling the pressure in the process station by regulating, for example, a throttle valve in the exhaust system of the process station, a gas flow into the process station, etc. The pressure control program may include instructions for maintaining the same pressure during the deposition of differing numbers of cycles on one or more substrates during the processing of the batch.

A heater control program may include code for controlling the current to a heating unit that is used to heat the substrate. Alternatively, the heater control program may control delivery of a heat transfer gas (such as helium) to the substrate.

In some implementations, there may be a user interface associated with a controller. The user interface may include a display screen, graphical software displays of the apparatus and/or process conditions, and user input devices such as pointing devices, keyboards, touch screens, microphones, etc.

The controller, in some implementations, may be a part of or coupled to a computer that is integrated with, coupled to the system, otherwise networked to the system, or a combination thereof. For example, the controller may be in the “cloud” or all or a part of a fab host computer system, which can allow for remote access of the wafer processing. The computer may enable remote access to the system to monitor current progress of processing operations, examine a history of past processing operations, examine trends or performance metrics from a plurality of processing operations, to change parameters of current processing, to set processing steps to follow a current processing, or to start a new process. In some examples, a remote computer (e.g. a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. It should be understood that the parameters may be specific to the type of process to be performed and the type of tool that the controller is configured to interface with or control. Thus, as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the processing and/or manufacturing of semiconductor wafers.

The system software may be organized in many different ways that may have different architectures. For example, various chamber component subroutines or control objects may be written to control operation of the chamber components necessary to carry out the deposition processes (and other processes, in some cases) in accordance with the disclosed embodiments.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of wafers to and from tool locations and/or load ports in a semiconductor manufacturing factory.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A semiconductor device manufacturing apparatus comprising:
a process chamber;
at least one sensor having access to the process chamber; and
a controller communicatively coupled to the at least one sensor, the controller configured to:
(a) introduce a chamber cleaning species to the process chamber to remove a coating from one or more components of the process chamber without excitation or generation of a plasma within the process chamber;
(b) detect, using the at least one sensor, spectral characteristics of electromagnetic radiation emitted in the process chamber during chamber cleaning; and
(c) from the spectral characteristics, determine that at least a portion of the electromagnetic radiation emitted in process chamber is caused by a chemical reaction of the chamber cleaning species with the coating or with at least one of the one or more components of the process chamber.

2. The semiconductor device manufacturing apparatus of claim 1, wherein the chemical reaction comprises a recombination reaction.

3. The semiconductor device manufacturing apparatus of claim 1, wherein the determination that at least the portion of the electromagnetic radiation is caused by the chemical reaction comprises an evaluation of spectral patterns obtained using the at least one sensor against reference spectral patterns.

4. The semiconductor device manufacturing apparatus of claim 3, wherein the controller is further configured to:
determine a chamber clean endpoint based at least on a determination that at least the portion of the electromagnetic radiation is caused by a chemical reaction with the one or more components of the process chamber; and
adjust one or more processes related to the process chamber based on the determination of the chamber clean endpoint.

5. A method of detecting clean endpoint, the method comprising:
(a) introducing a chamber cleaning species to a process chamber to remove a coating from one or more components of the process chamber without excitation or generation of a plasma within the process chamber;
(b) generating a reference plasma;
(c) detecting spectral characteristics of electromagnetic radiation emitted by one or more species excited by the reference plasma in the process chamber; and
(d) from the spectral characteristics, determining that the coating has been removed from at least one of one or more components of the process chamber.

6. The method of claim 5, wherein:
the spectral characteristics comprise one or more spectral patterns detected by a spectral sensor and having one or more aspects associated therewith; and
the determining that the coating has been removed comprises (i) evaluating the one or more spectral patterns against a reference library of spectral bands, and (ii) determining whether there is at least a partial match between the one or more aspects of the one or more spectral patterns and the reference library.

7. The method of claim 6, further comprising:
determining the clean endpoint based at least on the determining that the coating has been removed; and
adjusting one or more processes related to the process chamber based on the determining of the clean endpoint.

8.-10. (canceled)

11. An apparatus for monitoring and controlling a semiconductor device manufacturing equipment, the apparatus comprising:
at least one spectral sensor; and
a controller communicatively coupled to the at least one sensor, the controller configured to:
detect, using the at least one spectral sensor, spectral characteristics of emissions from within an internal portion of the semiconductor device manufacturing equipment; and
responsive to a determination that a desired process condition within the internal portion has not been met based on the detected spectral characteristics, adjust a process associated with the semiconductor device manufacturing equipment toward the desired process condition.

12. The apparatus of claim 11, wherein the desired process condition comprises an endpoint of a chamber cleaning process, a substantial absence of a hazardous material in the internal portion, or a substantial absence of a gas species in the internal portion

13.-20. (canceled)
